(19) United States
(12) Patent Application Publication
(10) Pub. No.: US 2003/0158842 A1
(43) Pub. Date: Aug. 21, 2003

(54) Adaptive acceleration of retrieval queries

(76) Inventors: Eliezer Levy, Haifa (IL); Ziv Kfir, Tel-Aviv (IL); Yiftach Kaplan, Givat-Shmuel (IL); Rachel Ben-Eliahu, Jerusalem (IL); Itzhak Turkel, Ramat-Hasharon (IL); Reuven Moskovich, Tel-Aviv (IL); Eliav Menachi, Ashdod (IL); Ran Giladi, Omer (IL); Shahar Gang, Kiryat-Ono (IL); Yehuda Weinraub, Beer-Sheva (IL); Michael Shurman, Bat-Hefer (IL); Albert Berlovitch, Ramat-Gan (IL)

Correspondence Address: William H. Dippert, Esq., Reed Smith LLP, 29th Floor, 599 Lexington Avenue, New York, NY, 10022-7650, US

(21) Appl. No.: 10/347,033

(22) Filed: Jan. 17, 2003

Related U.S. Application Data
(60) Provisional application No. 60/359,247, filed on Feb. 21, 2002.

(30) Foreign Application Priority Data
Feb. 21, 2002 (WO) PCT/IL02/00135

(51) Int. Cl. G06F 7/00

(52) U.S. Cl. 707/3; 707/2

(57) ABSTRACT

A database server accelerator, comprising a plurality of query execution machines, adapted to resolve database queries, a plurality of respective memory units, adapted to cache data from the database, each memory unit being accessible only by its respective execution machine, and a data-manager adapted to determine the data to be cached in each of the plurality of memory units.

### RELATED APPLICATIONS

This application claims the benefit under §119(e) of U.S. provisional patent application No. 60/359,247, filed on Feb. 21, 2002, the disclosure which is incorporated herein by reference.

### FIELD OF THE INVENTION

The present invention relates to data storage access systems.

### BACKGROUND OF THE INVENTION

Database servers are used to manage databases and provide data to applications in response to database queries. The databases are generally formed of tables whose fields are referred to as columns and each record is a row. The database server receives database access commands, which are generally provided in the SQL language. The database access commands include database queries and database updates. The database server changes the contents of the database responsive to the database updates and provides data responsive to the queries. Methods of responding to queries by database servers are well known in the art. One of the major attributes of a database server is the speed at which it provides query results.

Database servers are limited in the number of queries they can serve in a given period, by the processing power of the database server and by the throughput of a storage device storing the database. Increasing the number of database queries serviced in a given period, may be performed by adding an additional database server and a load balancer which distributes the queries between the database servers. Adding an additional database server is expensive and requires synchronization of the data provided by the database servers.

There exist software techniques that are used to enhance the operation speed of the database server. For example, some compilers that translate the SQL queries into segments of operator statements executable by the processors of the database server, attempt to optimize the segments of executable statements during compilation. The optimization includes, for example, determination of when to perform a sort, e.g., before or after other operations, according to operation cost.

It also has been suggested to create indices, which provide fast access to respective columns, for some of the columns of the database. The indices to be created are determined off-line by a database manager or by a computer program. The computer program may, for example, collect the types of queries directed to the database, and accordingly determine automatically, off-line, which indices should be created.

One method of enhancing the response time to queries is providing an enhancement database unit, such as the dbCruiser provided by infoCruiser, which caches frequently accessed information in a main memory unit, and, using the cached information, responds to some of the queries directed to the database server, instead of the database server. The dbCruiser uses principles of fuzzy logic and uncertainty theory to adaptively determine which portions of the database are cached in the main memory, as described in U.S. patent publication 2002/0087798, which is incorporated herein by reference. Alternatively, an administrator may set the portions of the database cached in the main memory.

### SUMMARY OF THE INVENTION

Multi-Machine Accelerator

An aspect of some embodiments of the invention relates to a database server accelerator, which has a plurality of separate execution machines associated with separate memory units. The plurality of execution machines are optionally included in a single housing and/or are controlled by a single controller. In some embodiments of the invention, at least some queries handled by the accelerator are resolved jointly by a plurality of the execution machines. Use of a plurality of execution machines that have separate memory units, in a single accelerator, allows the accelerator to have an amount of memory larger than the address space that can be accessed by a single execution machine.

In some embodiments of the invention, a single resource governor controls the contents of a plurality of the memory units associated with different ones of the execution machines, so as to maximize the acceleration affect of the accelerator. In some embodiments of the invention, the resource governor controls the contents of the memory units in a manner which prevents a plurality of memory units from caching the same database portions. Alternatively or additionally, the resource governor instructs a plurality of the memory units to store a single database portion in a plurality of the memory units for better parallel resolution of one or more frequent database queries.

In some embodiments of the invention, a single compiler is used to convert database queries received by the accelerator into code segments executable by the execution machines, for at least a plurality of the execution machines.

Non-Specific Compilation

An aspect of some embodiments of the present invention relates to a compiler of database access commands for a multi-machine database server. The compiler converts database access commands into plans formed of executable operator statements, without stating the specific machine which is to carry out the statements. Since the compiled commands do not include data position information, the compiled commands may be used even after the positions of some of the data accessed by the commands changes locations between machines. Thus, before execution of a command, the command only needs to be adjusted to the positions of the data and there is no need to recompile the command. This allows, in some embodiments of the invention, dynamic movement of data between the machines of the database server at a relatively high rate, without wasting processing resources on recompilation.

Optionally, at least some of the plans generated by the compiler are executed by a plurality of machines of the database server. These plans are optionally moved between the machines executing the plan, each machine executing a portion of the plan and moving the plan and the resultant data to a next machine for further processing.

Moving Data Between Machines

An aspect of some embodiments of the present invention relates to a multi-machine database server, which includes a resource governor that dynamically determines the database portions hosted by each of the machines.

In some embodiments of the invention, the resource governor optionally moves data portions between the machines, when determined to be advantageous, for example, in order to concentrate data required by popular queries in as few execution machines as possible. Optionally, the resource governor determines which data portions are to be handled by each machine based on statistics on the database commands (e.g., queries) recently received by the database server. By dynamically adjusting the data handled by each of the machines, the data can be placed in the machines according to the queries currently being received by the database server. Thus, the number of times queries, and the data they manipulate, need to be transferred between machines during resolution of the queries, can be reduced.

In some embodiments of the invention, the multi-machine database server comprises a primary database server, which performs substantially all the tasks required from a database server. Alternatively, the multi-machine database server comprises a database accelerator, which performs only some database tasks, for example only data retrieval tasks.

In some embodiments of the invention, the resource governor periodically, for example every 3-5 minutes, reviews the queries recently received by the database server and accordingly determines which database portions are to be handled by each of the machines. The periodic operation of the resource governor may have shorter (e.g., 10-20 seconds) or longer (e.g., 1-2 hours) durations than indicated above, depending on the type of queries forwarded to the database and/or the frequency at which the types of queries change.

In some embodiments of the invention, at least some of the decisions of the resource governor result in a transfer of data already stored in a first one of the machines to a second machine, different from the first. Alternatively or additionally, the decisions result in loading data portions from a secondary memory (optionally not associated with a single execution machine) to the memory units. The secondary memory may be used to store data which is determined to be cached but is not accessed at a high rate. Further alternatively or additionally, the decisions result in caching data portions from a database being accelerated. Further alternatively or additionally, the decisions result in generating additional copies of one or more data portions from the database, so that the same data is directly accessible by more than one execution machine.

Selecting Indices

An aspect of some embodiments of the present invention relates to a database server that periodically determines which indices should be created for columns of tables stored in the database and accordingly automatically creates the indices. Optionally, the database server monitors the queries recently directed to the server, and accordingly determines which indices are most worthwhile to create. In some embodiments of the invention, the determination of which indices are to be created is based on the popularity of the recently received queries. Thus, the created indices are those which are expected to provide maximal acceleration in view of recently received database queries.

Non-Executable Directives

An aspect of some embodiments of the present invention relates to a compiler which translates database access commands into operator segments, i.e., compiled plans. At least one of the compiled plans includes a non-executable directive which is replaced by an executable portion after the compilation. The non-executable directive represents a group of a plurality of equivalent executable portions, from which the replacement executable portion is selected, after the compilation. The execution portions in the group of equivalents of a non-executable directive optionally differ in the method in which they perform a required task represented by the directive, while the results of the equivalent execution portions are substantially the same.

In some embodiments of the invention, the selection of the executable portion from the group of equivalents is performed responsive to at least one attribute of the data manipulated by the executable portion, for example, the number of rows in the manipulated data, the time required so far to execute the compiled plan, the importance of the compiled plan and/or the expected time remaining until completion of the plan. For example, for a plan nearly completed, an executable portion that minimizes execution time of the plan may be selected, while for a plan with substantial time remaining until completion, an executable portion that minimizes throughput may be selected.

Alternatively or additionally, the selection is performed responsive to dynamic or static parameters of the machine executing the compiled plan. Dynamic parameters may include, for example, the available memory of the machine and/or the load (e.g., the number of plans waiting for execution) on the machine. Static parameters may include, for example, the processing power of the machine and/or the size of the memory associated with the machine, when the at least some of the execution machines differ in one or more static parameters. Further alternatively or additionally, the selection of the executable portion is performed responsive to execution times of the compiled plan with the different possible executable portions. Optionally, at the first few times the compiled plan is executed, some or all of the possible executable portions are selected and the execution times are measured for the different equivalent portions. Thereafter, the executable portion with the best response time is selected.

Optionally, the selection of the executable portion from the group of equivalents is performed during the execution. In some embodiments of the invention, the selection is performed by an execution machine that executes at least a portion of the compiled plan, optionally by the machine that executes the selected execution portion. Alternatively, the selection of the executable portion from the group of equivalents is performed by a dispatcher that passes the compiled plans to the execution machines, for example when the execution is performed based on the importance of the query.

Selecting the executed portion after the compilation allows better optimization of the compiled plans according to the manipulated data at the time of execution. Thus, the optimization can be performed based on information on the data which is not available during compilation, for example, the accurate size of an intermediate table (instead of a general approximation available during compilation). In addition, the compilation can be performed once for a plurality of repetitions of the compiled database command, without loosing the benefits of optimization of the compilation based on attributes of the manipulated data.

In some embodiments of the invention, the compiler does not relate at all to attributes of the manipulated data, and all optimizations responsive to the data size are performed after compilation. That is, in any case that there is a possibility to perform one of a plurality of different commands, the compiler inserts a non-executable directive to the plan and does not attempt to select a specific directive. Alternatively, the compiler relates to the attributes of the database for at least some of the statements of the compiled query. For example, for statements that manipulate base tables whose size is substantially known, the compiler optionally selects a specific operator to be used.

In some embodiments of the invention, the executable portions represented by the directives include single operator statements. For example, a directive may represent a join operation, which is to be performed in one of a plurality of different methods. The general join directive is replaced after compilation by a single operator statement that performs the join operation using a selected method. Alternatively or additionally, one or more of the directives represents a plurality of segments of one or more operators, at least one of which includes a sequence of a plurality of operators. Optionally, the operator segments include standard library segments for performing complex operations. Alternatively or additionally, one or more of the operator segments is generated during compilation of the command. For example, the compiler may generate a plurality of possible operator segments from which one is to be selected at a later time, e.g., during execution. The plurality of segments may be optimized to achieve different goals, for example throughput (i.e., the number of queries handled in a specific time) verses response time (i.e., the time between receiving a query and providing a response to the query). During execution it is optionally determined whether throughput or response time is more important for the specific query, and accordingly the executable portion is selected.

In some embodiments of the invention, the selected executed portion comprises the entire compiled plan. Optionally, the compiler generates a plurality of plans for the command, from which one plan is selected when the command is to be executed. The plurality of plans are optionally optimized during compilation based on different assumptions on the manipulated data. In some embodiments of the invention, the plurality of plans are generated at substantially the same time. Alternatively or additionally, the plurality of plans are generated at different times, for example under different data conditions. The selection is optionally performed based on a comparison between current data conditions and the conditions at the times of the different compilations.

Selecting Cached-Data Based on Queries

An aspect of some embodiments of the present invention relates to determining which data is to be cached by a database accelerator, by selecting a group of queries to be handled by the accelerator and caching the data required by those queries. In some embodiments of the invention, only queries in the selected group are provided thereafter to the accelerator. Alternatively, queries not in the selected group, but relating to data cached by the accelerator, may be handled by the accelerator, for example when the accelerator is relatively lightly loaded.

In some embodiments of the invention, the selected queries used in determining the data to be cached by the accelerator are selected at least partially according to the benefit to the execution of the queries from being handled by the accelerator. In some embodiments of the invention, the determination is performed responsive to previously measured execution times of the queries. Queries that are expected to be handled much faster by the accelerator than by the primary database server are optionally given precedence in being handled by the accelerator. Thus, the decision of which queries are to be cached does not only reduce the load on the primary server but does so in a manner which increases the response time of the queries handled by the accelerator.

Clustering of Queries

An aspect of some embodiments of the present invention relates to a method of determining the data organization of a database. The method includes accumulating queries recently directed to the database, clustering the accumulated queries into clusters that relate to same and/or similar data portions and determining the data organization according to the data needs of the queries of one or more of the clusters. At least one of the clusters includes a plurality of non-identical queries. Optionally, each of the clusters is assigned a priority score and one or more clusters having best scores are related to in determining the data organization. The priority score of each cluster optionally depends on the resources required in order to accelerate the queries in the cluster and the expected benefit from accelerating the queries of the cluster. Alternatively, one or more of the clusters are selected arbitrarily, so as not to waste resources on assigning scores to the clusters.

Determining the data organization based on query clusters, rather than single queries, allows better utilization of the resources of the database server. Better utilization is achieved, for example, by optimizing the handling of relatively low importance queries which require similar data as one or more high importance queries.

Determining the data organization optionally comprises determining indices to be created by the database server. In some embodiments of the invention, the database server comprises a database accelerator. In some of these embodiments, determining the data organization comprises selecting data portions to be cached by the accelerator and/or the queries to be accelerated. Alternatively or additionally, determining the data organization comprises determining the partitioning of the cached data within the accelerator.

In some embodiments of the invention, the database server comprises a plurality of execution machines with separate respective memory units. In some of these embodiments, determining the data organization comprises determining which data portions are stored in each memory unit.

Query Load Balancing

An aspect of some embodiments of the present invention relates to determining whether a query is to be handled by a database accelerator, according to at least one attribute additional to whether the accelerator can handle the query with its currently cached data. Optionally, the at least one attribute comprises the current processing load of the accelerator and/or whether the query was previously compiled. Alternatively or additionally, the at least one attribute comprises an expected benefit to the handling of the query. In some embodiments of the invention, the expected benefit to the handling of the query comprises a relative response time and/or execution time of the accelerator verses the response time and/or execution time of an accelerated server. Alternatively or additionally, the expected benefit is a function of an expected accuracy of the handling of the query. For example, the accelerator may have fewer precision positions than the database server, and queries which require high precision may be directed only to the database server.

An aspect of some embodiments of the present invention relates to determining to which of a plurality of database servers to provide a query to be resolved, based on the type of the query. The determination is performed at least partially according to the expected benefit from passing the query to a specific database server. In some embodiments of the invention, the determination is performed responsive to previously measured execution times of the same or similar queries.

In some embodiments of the invention, the selection is performed between a plurality of primary database servers hosting the same data. Optionally, the selection is performed by a database load balancer that determines to which of the servers queries are to be forwarded. Alternatively or additionally, the database servers from which the selection is performed comprise a primary server and at least one database server accelerator. Optionally, at least some of the queries that can be handled by the accelerator in view of the data hosted by the accelerator are not handled by the accelerator, for example, since the queries are handled faster by the primary database server.

Partitioning of Tables

An aspect of some embodiments of the present invention relates to a database server that stores the data of at least some of the tables of a database in a plurality of separate groups of one or more columns (these groups of one or more columns are referred to herein as verticals). During processing of a database command, the database loads into its CPU the rows of a vertical rather than rows of the entire table. By separating the tables into smaller groups of columns, the processing time required for queries which relate to fewer than all the columns of a table is reduced. The database optionally stores the entire table, although in a plurality of different verticals. Alternatively, for some tables, the database stores a plurality of verticals including only a portion of a table, according to the amount of data required for processing database commands.

In some embodiments of the invention, the database server comprises a database accelerator which caches data from a primary database. In some embodiments of the invention, columns of a single table are cached into the accelerator in a plurality of verticals. The plurality of verticals may be stored in multi-machine accelerators in the same machine or in different machines.

An aspect of some embodiments of the present invention relates to a database server which stores the data of at least some of the tables of a database in a plurality of separate groups of sub-tables, selected responsive to the queries expected to be received by the database server. Optionally, the queries expected to be received are determined according to queries recently received by the database server and/or by a database server system including the database server along with other database resolution units (e.g., other database servers, query caches and/or database accelerators).

QoS

An aspect of some embodiments of the present invention relates to determining which database commands should be handled by an accelerator, at least partially according to quality of service (QoS) ratings of the commands. Optionally, commands having and/or deserving a high quality of service are given priority when determining which commands are handled by the accelerator. Alternatively, high QoS commands are given priority in being handled by a primary database server accelerated by the accelerator.

It is noted that the different aspects of the present invention may be implemented together in a single system or may be utilized separately in enhancing database systems. In some embodiments of the invention, only one or a few of the aspects are implemented.

There is therefore provided in accordance with an embodiment of the present invention, a database server accelerator, comprising a plurality of query execution machines, adapted to resolve database queries, a plurality of respective memory units, adapted to cache data from the database, each memory unit being accessible only by its respective execution machine, and a data-manager adapted to determine the data to be cached in each of the plurality of memory units.

Optionally, the plurality of execution machines are included in a single casing. Optionally, the accelerator includes a query dispatcher adapted to provide queries to the plurality of query execution machines. Optionally, the query dispatcher is adapted to provide at least some of the queries to a plurality of execution machines which jointly resolve the at least some queries. Alternatively or additionally, the query dispatcher is adapted to select one or more query machines to perform a query, at least partially according to the data referred to by the query and the data stored in the memory units. Optionally, at least one of the execution machines comprises a plurality of processors. Optionally, each of the plurality of processors of a specific execution machine can access all the address space of the respective memory unit of the execution machine. Optionally, at least one of the processors of a specific execution machine can access only a portion of the address space of the respective memory unit of the execution machine. Optionally, at least two of the execution machines have different processing powers. Alternatively, all the execution machines have the same processing power. Optionally, at least two of the memory units have different storage space. Alternatively, all the memory units have the same storage space. Optionally, at least two of the execution machines are adapted to resolve different types of queries.

Optionally, the data-manager is adapted to have each memory unit cache only data not stored in any of the other memory units. Alternatively, the data-manager is adapted to have at least two memory units store at least one common data portion. Alternatively or additionally, the data-manager is adapted to have at least two memory units cache the same data.

Optionally, the accelerator includes a compiler adapted to convert queries provided to a plurality of the execution machines into operator statements executable by the machines.

Optionally, the data-manager is adapted to determine the data to be cached according to a roster of queries recently received by a system including the accelerator. Optionally, the data-manager is adapted to determine the data to be cached based on the response times of the accelerator and at least one database server to at least one of the queries of the roster. Optionally, the data-manager is adapted to repeatedly determine periodically the data to be cached in each of the plurality of memory units.

There is further provided in accordance with an embodiment of the present invention, a method of preparing a database command for execution by a multi-executor database server, comprising receiving a high level database command, retrieving, from an execution plan cache, an execution plan including one or more executable operator statements, corresponding to the received database command, the execution plan not defining which executor is to execute each of the operator statements; and converting the execution plan into an operational plan that, for each of the operator statements, states a group of one or more executors from which an executor which is to execute the statement is to be selected.

Optionally, converting the execution plan into a operational plan comprises converting into a operational plan that states for each of the operator statements a single executor which is to execute the statement. Optionally, converting the execution plan into a operational plan comprises converting using a method adapted to minimize the number of executors used in handling the command. Optionally, for each statement, the group of one or more executors includes all the executors stated for other statements of the plan that generate data required by the statement.

There is further provided in accordance with an embodiment of the present invention, a database server, comprising a plurality of database execution machines, a plurality of memory units, associated respectively with the execution machines, adapted to store data of a database; and a resource governor adapted to periodically determine which portions of the database are to be stored in each of the memory units.

Optionally, the resource governor is adapted to determine a transfer of a database portion from a first memory unit to a second memory unit. Optionally, the resource governor is adapted to determine which portions of the database are to be stored in each of the memory units responsive to a roster of queries recently received by a system including the database server. Optionally, the resource governor is adapted to group the queries of the roster into clusters and to determine the portions of the database to be stored in each of the memory units in a manner which preferentially places data referenced by queries of a single cluster in the same memory unit.

There is further provided in accordance with an embodiment of the present invention, a database server, comprising at least one memory unit adapted to store data of a database, a resource governor adapted to periodically determine which indices should be created for which portions of the database stored in the memory unit, and an index creating unit adapted to automatically create the indices determined by the resource governor, responsive to the periodic determination.

Optionally, the resource governor is adapted to determine the indices that should be created at least partially according to a roster of queries recently directed to a system including the database server. Optionally, the resource governor is adapted to organize the queries of the roster into clusters, to assign importance scores to the clusters and to determine the indices to be created for one or more of the clusters at least partially according to an order of the scores of the clusters.

Optionally, for one or more of the clusters, the resource governor is adapted to determine for one or more columns referenced by queries of the cluster, access types most commonly used in accessing the columns and to select one or more indices for the column at least partially according to the determined access types.

There is further provided in accordance with an embodiment of the present invention, a method of resolving a database command, comprising receiving a high level database command, retrieving an execution plan corresponding to the received database command, the execution plan including at least one non-executable replaceable directive representing a group of a plurality of different sequences of one or more directives, which perform the same task, and replacing the non-executable replaceable directive by one of the sequences of the group.

Optionally, receiving the high level database command comprises receiving an SQL command. Optionally, replacing the non-executable directive comprises selecting one of the sequences of the group to replace the non-executable directive, at least partially according to at least one parameter of data generated by the at least one of the directives of the plan executed before the replacement.

Optionally, the at least one parameter comprises a number of rows of in the generated data. Optionally, replacing the non-executable directive comprises selecting one of the sequences of the group to replace the non-executable directive, depending on one or both of a time utilized so far to execute the plan or an expected time remaining until completion of the plan. Optionally, replacing the non-executable directive comprises selecting one of the sequences of the group to replace the non-executable directive, depending on at least one state parameter of an execution machine executing the plan.

Optionally, the at least one state parameter comprises a work load of the execution machine. Optionally, the at least one state parameter comprises a number of queries waiting to be executed by the machine and/or an amount of available memory in the machine.

Optionally, replacing the non-executable directive comprises replacing after executing at least one of the directives of the plan. Alternatively or additionally, replacing the non-executable directive comprises replacing by a processor which is to execute the segment replacing the non-executable directive. Optionally, replacing the non-executable directive comprises replacing by an executor which did not generate the execution plan. Optionally, each of the sequences of one or more directives comprises a single directive. Optionally, at least one of the sequences of one or more directives comprises a plurality of directives.

Optionally, the method includes estimating an execution time of each of a plurality of the sequences of the group and replacing the non-executable directive comprises replacing by a sequence having a shortest execution time.

There is further provided in accordance with an embodiment of the present invention, a method of caching data by a database server accelerator, comprising selecting queries to be handled by the accelerator and caching the data required to resolve the selected queries, responsive to the selection.

Optionally, selecting the queries to be handled by the accelerator comprises estimating, for a plurality of queries, the benefit to the queries from handling the queries by the accelerator and selecting the queries to be handled by the accelerator responsive to the estimation.

Optionally, estimating the benefit to the queries comprises estimating, for each of the plurality of queries, the difference between the handling time of the query by the accelerator and the handling time of the query by at least one database server.

Optionally, determining which queries are to be handled by the accelerator comprises assigning each of the queries an acceleration score and determining the handled queries at least partially according to the scores, preferring queries with higher scores to be handled by the accelerator. Optionally, determining the handled queries comprises grouping the queries into clusters and determining one or more clusters of queries to be handled. Optionally, grouping the queries into clusters comprises grouping queries relating to the same data columns in same clusters. Optionally, better acceleration scores are given to queries with higher QoS ratings. Optionally, the acceleration score increases with the popularity of the query.

There is further provided in accordance with an embodiment of the present invention, a method of determining a data organization of data of a database, comprising accumulating a roster of queries recently directed to the database, grouping the queries of the roster into a plurality of clusters, arranging the clusters in an order in which their data is to be handled, and determining an organization for the data of queries of one or more clusters at least partially according to the order from the arranging.

Optionally, accumulating the roster of queries comprises accumulating queries directed to the database in a recent predetermined time period. Optionally, accumulating the roster of queries comprises accumulating queries which were recently directed to the database at least a predetermined number of times. Optionally, grouping the queries into clusters comprises grouping the queries at least partially according to the data portions they reference.

Optionally, the method includes defining a query distance function which provides a distance measure for pairs of queries and wherein grouping the queries into clusters comprises grouping queries into clusters which each has a respective hub query, such that the distance between each query and the hub of the cluster to which the query is assigned is shorter than the distance to any other hub. Optionally, the value of the query distance function depends on the number of data portions referenced by both the queries to which the function is applied. Optionally, the value of the query distance function depends on the sizes of data portions referenced by both the queries to which the function is applied.

Optionally, the value of the query distance function depends on the similarity of the access types used by the queries to which the function is applied in accessing data portions referenced by both the queries. Optionally, grouping the queries into clusters comprises grouping such that each query is included in only a single cluster. Optionally, grouping the queries into clusters comprises grouping such that all the data portions referenced by queries of a single cluster can be hosted by a single execution machine of a server of the database.

Optionally, arranging the clusters comprises assigning each cluster a score and organizing the clusters at least partially according to the score values. Optionally, the cluster score depends on resources required in order to handle the queries of the cluster and/or in order to organize the data required by the cluster. Optionally, the organization is performed for a database accelerator and wherein the cluster score depends on an expected advantage from handling the queries of the cluster by the accelerator as compared to handling by a database server associated with the accelerator.

Optionally, determining an organization for the data comprises determining which indices are to be created and/or which data portions are to be cached by an accelerator. Optionally, determining an organization for the data comprises determining a partitioning of one or more data tables. Optionally, determining an organization for the data comprises determining which data portions are to be hosted by each of a plurality of separate execution machines.

There is further provided in accordance with an embodiment of the present invention, a method of determining whether a query is to be handled by an accelerator, comprising determining whether the query can be resolved by the accelerator with its currently cached data, determining at least one additional attribute of the accelerator or the query, and determining whether to handle the query by the accelerator, responsive to the at least one additional attribute.

Optionally, the at least one additional attribute comprises a current load of the accelerator. Optionally, the at least one additional attribute comprises an expected response time of the accelerator for the query. Optionally, the at least one additional attribute comprises an expected response time of a database server accelerated by the accelerator, for the query. Optionally, the at least one additional attribute comprises whether the accelerator has a compiled version of the query.

There is further provided in accordance with an embodiment of the present invention, a database server, comprising at least one memory unit adapted to store data of a database including tables, in verticals including one or more columns of the table, at least one of the tables being stored in a plurality of separate verticals; and an execution machine adapted to resolve queries using the data in the at least one memory unit, the execution machine adapted to always load into a processor of the machine entire rows of verticals on which it operates.

Optionally, the execution machine is not adapted to execute directives that relate to a plurality of verticals of a single table. Optionally, the server includes a resource governor adapted to determine which columns of a table are to be stored in the at least one memory unit in a single vertical, at least partially according to directives expected to be performed by the execution machine. Optionally, the at least one memory unit is adapted to store only a portion of at least one table.

There is further provided in accordance with an embodiment of the present invention, a database server, comprising at least one memory unit adapted to store data of a database including tables, at least one of the tables being stored in a plurality of separate sub-portions, an execution machine adapted to resolve queries using the data in the at least one memory unit; and a resource governor adapted to determine the sub-groups in which the data to be stored in the at least one memory unit are to be organized, at least partially according to the queries expected to be received by the database server.

Optionally, the execution machine is not adapted to execute directives that relate to data in a plurality of sub-portions of a single table.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a database access system, in accordance with some embodiments of the present invention;

FIG. 2 is a schematic block diagram of a database accelerator, in accordance with an embodiment of the present invention;

FIG. 3 is a flowchart of the acts performed in determining whether to forward database commands to an accelerator, in accordance with an embodiment of the present invention;

FIG. 4 is a flowchart of the acts performed by a database accelerator, on received queries, in accordance with an embodiment of the present invention;

FIG. 5 is a schematic illustration of an execution plan, in accordance with an embodiment of the present invention;

FIG. 6 is a flowchart of acts performed by a dispatcher in coloring an execution plan, in accordance with an embodiment of the present invention;

FIG. 7 is a schematic illustration of a portion of an execution plan, useful in explaining the selection of an execution machine (EM) to execute a directive of the plan, in accordance with an embodiment of the present invention;

FIG. 8 is a schematic illustration of the actions performed by an accelerator resource governor, in accordance with an embodiment of the present invention;

FIG. 9 is a flowchart of acts performed in vertical decomposition of tables referenced by a cluster, in accordance with an embodiment of the present invention;

FIG. 10 is a flowchart of acts performed in determining which indices are to be used for a cluster of queries, in accordance with an embodiment of the present invention;

FIG. 11 is a flowchart of acts performed in selecting memory units for each of the portions of the database stored in the accelerator, in accordance with an exemplary embodiment of the present invention; and

FIG. 12 is a flowchart of acts performed during a clustering procedure, in accordance with an embodiment of the present invention.

### DETAILED DESCRIPTION OF EXEMPLARY EMBODIMENTS

System

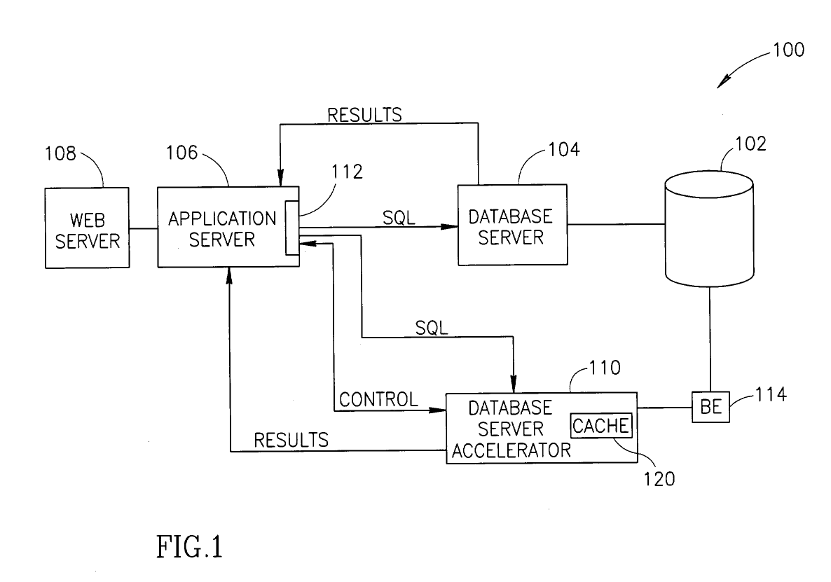

FIG. 1 is a schematic illustration of a database access system 100, in accordance with an embodiment of the present invention. Database access system 100 comprises a storage disk 102, or any other storage unit, which stores a database. A database server 104 receives database access commands, directed to the database stored in storage disk 102. The commands directed to database server 104 are, for example, in the SQL database query language, in the Extendible Markup Language (XML), or in other suitable languages, such as executable languages of database servers. The database access commands include, for example, database update commands, which cause database server 104 to alter the data stored in disk 102, and data retrieval queries, which are responded to by database server 104 with requested data from the database. An application server 106 prepares database commands provided to database server 104. In an exemplary embodiment of the invention, application server 106 prepares the database commands in response to user commands received from a web server 108. Alternatively or additionally, application server 106 receives user commands from other computers, processors and/or user interfaces.

Optionally, web server 108 and/or applications providing queries to the web server may mark queries as important (e.g., having a high QoS) and these queries are given precedence, when possible. Alternatively or additionally, queries are considered important when they are received from specific clients and/or when they relate to specific database portions marked as important.

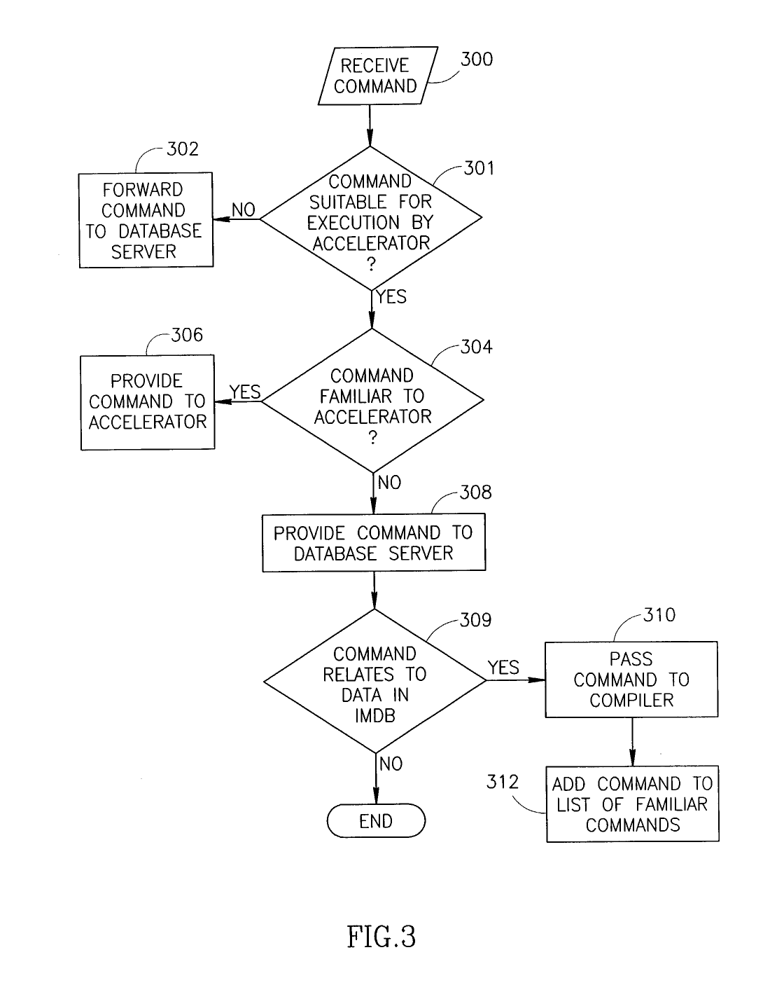

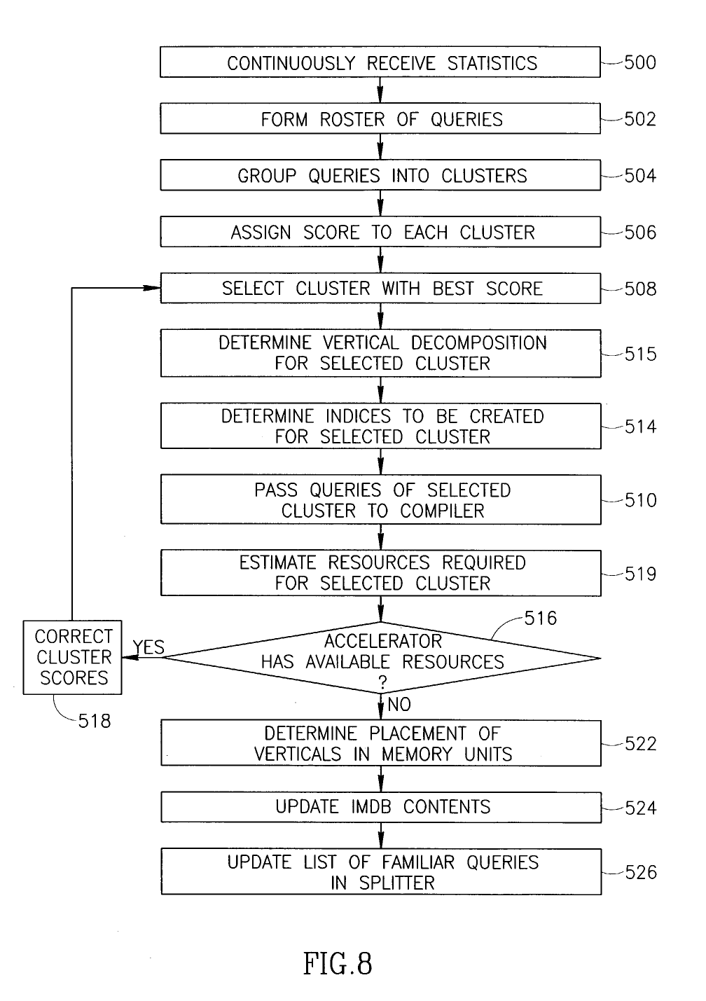

In some embodiments of the invention, in order to enhance the operation of database system 100, a database server accelerator 110 is positioned in parallel to database server 104. Optionally, a splitter 112, hosted for example by application server 106, examines the database commands directed to database server 104 and determines, based, for example, on instructions from accelerator 110, which commands are to be forwarded to accelerator 110, instead of to database server 104. An exemplary method of the operation of splitter 112 is described hereinbelow with reference to FIG. 3. Splitter 112 optionally also collects statistics on the commands directed to database server 104 and/or to accelerator 110. According to the accumulated statistics, accelerator 110 determines, for example as described hereinbelow with reference to FIG. 8, which database commands are to be referred by splitter 112 to accelerator 110 instead of to database server 104.

Accelerator 110 optionally includes a cache memory, referred to herein as an in-memory database (IMDB) 120, which stores portions of the database that accelerator 110 uses in resolving database commands. Optionally, in-memory database 120 comprises one or more main memory units that allow fast access to the contents of the in-memory database. Alternatively or additionally, in-memory database 120 includes other types of storage units. In some embodiments of the invention, in-memory database 120 includes a secondary storage unit. The secondary storage unit may be used when the main memory units are exhausted and/or for data which is accessed less often, as described below.

A back end (BE) unit 114 optionally loads data from storage disk 102 into in-memory database 120 and/or updates values of data in in-memory database 120, responsive to changes in storage disk 102. Back end unit 114 may use, for example, the redo log of the database, as is known in the art, as a source of data for updating in-memory database 120. Use of the redo log is considered a relatively low intrusive method that minimizes the load on database server 104 due to the operation of accelerator 110. Alternatively or additionally, any other update methods known in the art are used.

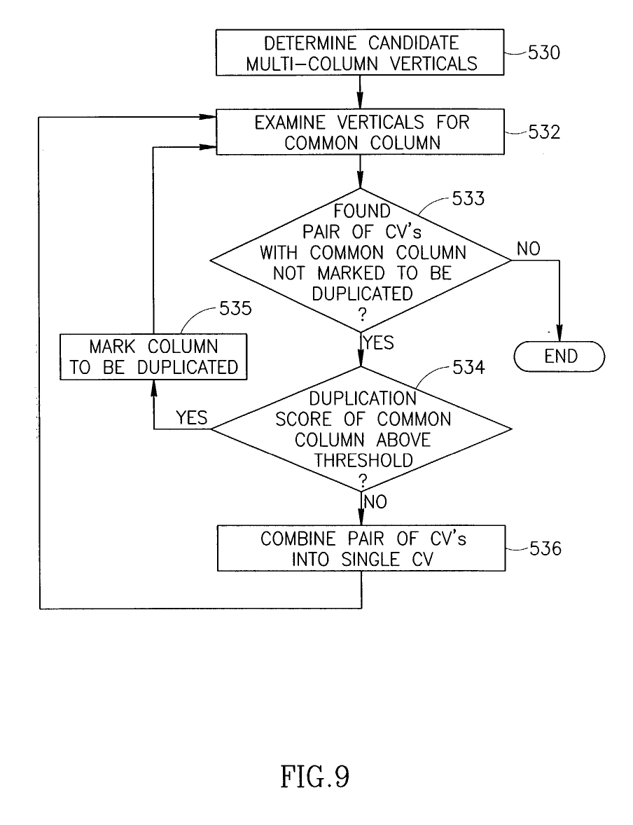

As is known in the art, the data in the database is optionally organized in tables. Each table includes one or more columns, which represent the different data stored in the table. Each table also includes one or more rows, each row representing an entry of the table, generally having values for each of the columns of the table. For example, a table correlating names and salaries may have a column of names and a column of salaries, and rows for each person listed in the table. In some embodiments of the invention, the data stored in in-memory database 120 is partitioned into groups of one or more columns, referred to herein as verticals. An exemplary method of partitioning the database tables into verticals is described hereinbelow with reference to FIG. 9.

In the following description, tables, verticals and columns copied from storage disk 102 are referred to as base tables, base verticals and base columns, respectively, while verticals generated by accelerator 110 are referred to as intermediate verticals. The term intermediate verticals, therefore, as used herein also includes final results.

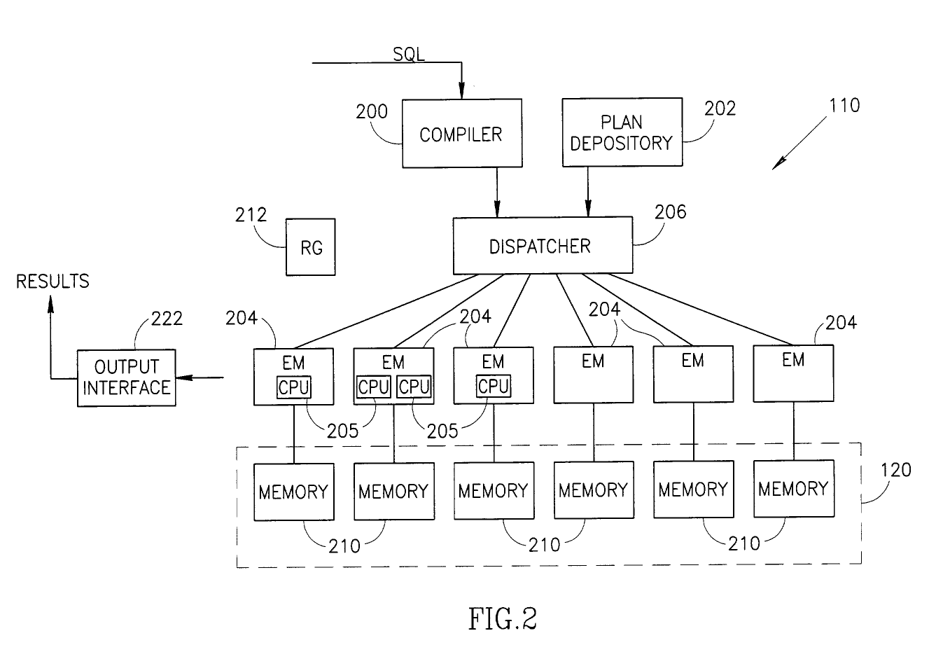

FIG. 2 is a schematic block diagram of accelerator 110, in accordance with an exemplary embodiment of the present invention. In the embodiment of FIG. 2, accelerator 110 comprises a plurality of execution machines (EMs) 204 that perform database instructions directed to accelerator 110. Each execution machine 204 optionally comprises one or more processors (CPUs) 205. In some embodiments of the invention, all of execution machines 204 include, for simplicity, the same number of processors 205. In other embodiments of the invention, different execution machines 204 include different numbers of processors 205, allowing better fitting of different tasks to specific execution machines 204. Processors 205 may all have the same processing power or may have different amounts of processing power.

In some embodiments of the invention, each EM 204 has a respective EM memory unit 210, which stores data on which the respective execution machine 204 operates. In these embodiments, EM memory units 210, together, optionally form in-memory database 120. In some embodiments of the invention, for simplicity, the capacities of all of EM memory units 210 are substantially the same. Alternatively, different EM memory units 210 have different capacities, so as to better fit specific different tasks handled by accelerator 110. In some embodiments of the invention, the capacities of EM memory units 210 are at least partially correlated to the processing power of their respective EMs 204, such that EMs with a relatively high processing power are associated with a relatively large EM memory unit 210. In an exemplary embodiment of the invention, some or all of EM memory units 210 are of the largest possible size which can be accessed by their respective EM 204.

The plurality of CPUs 205 within a single EM 204 optionally operate in parallel on different queries that relate to the same data. Alternatively, the plurality of CPUs 205 operate in parallel on different queries that relate to different verticals hosted by the memory unit 210 of the particular EM 204. Further alternatively or additionally, one or more the plurality of CPUs 205 operate in parallel on different operator statements of a single query. Further alternatively or additionally, any other parallel query processing methods known in the art are used to govern the operation of the CPUs 205 of a single EM 204. Optionally, the usage of CPUs 205 of a single EM 204 is controlled by a multi-processor operating system, using methods known in the art.

In some embodiments of the invention, each of CPUs 205 within a single EM 204 has access to the entire address space of the memory unit 210 associated with the EM 204. Alternatively or additionally, at least some of the portions of the memory of an EM 204 are assigned for use by fewer than all the CPUs 205 of the EM. For example, in order to simplify the hardware of EM 204 (e.g., relax the parallelism constraints) each CPU 205 has a portion of memory unit 210 for which it is a sole user. In some embodiments of the invention, the base verticals in the memory unit 210 of the EM 204 are shared by all of CPUs 205 of the EM, as they are only read and not written to, while the intermediate storage space in memory unit 210 is distributed among CPUs 205, since it is used as both a read and write memory. Optionally, the intermediate storage space of each CPU 205 is dynamically adjusted according to the tasks being carried out by the CPUs 205. For example, within a single EM 204, a memory portion may be first assigned to a first CPU 205, which generates an intermediate table, and then transferred to a second CPU 205 that uses the intermediate table.

In some embodiments of the invention, accelerator 110 includes a resource governor (RG) 212 that controls the data contents of memory units 210 and the commands handled by accelerator 110, for example, as described hereinbelow with reference to FIG. 8. Optionally, resource governor 212 receives statistics from splitter 112 and/or from other elements of system 100, and accordingly controls and/or determines the commands handled by accelerator 110.

Accelerator 110 optionally includes a compiler 200 that translates database commands received from application server 106 into execution plans of operator statements executable by EMs 204. Compiler 200 optionally operates under the instructions of resource governor 212, based on its determination of the commands to be handled by accelerator 110. Compiler 200 optionally is adapted to translate database queries from a plurality of different languages. In some embodiments of the invention, compiler 200 is adapted to receive compiled queries from other database servers and convert the received compiled queries into plans executable by EMs 204.

In some embodiments of the invention, for some commands, compiler 200 generates a plurality of different plans that optimize the resolution of the command for different parameters. For example, a first plan may optimize the resolution of the command, when an intermediate table is larger than a specific size, and a second plan may optimize the resolution of the command, when the intermediate table is smaller than the specific size. Alternatively or additionally, different plans are generated in order to achieve different optimization goals. For example, a first plan may be prepared for throughput optimization, while a second plan is generated for response time optimization.

In some embodiments of the invention, accelerator 110 includes a plan depository 202 in which compiled plans of previously received instructions are stored. Optionally, the execution plans include information on which operator statements can be performed in parallel. In some embodiments of the invention, the compiled plans are in the form of operator statement trees (as shown for example in FIG. 5) in which each node represents an operator statement. Each operator statement is performed after the performance of the operator statements of all its child nodes are completed. A dispatcher 206 optionally receives compiled plans, converts the plans into executable code segments and provides the code segments to one or more of execution machines 204. In some embodiments of the invention, when a command has a plurality of respective plans, dispatcher 206 selects the plan to be used, according to the information available to dispatcher 206 on the data manipulated by the plans. Alternatively or additionally to having a single dispatcher, each EM 204 has a respective dispatcher, which performs some or all of the dispatching tasks, such as determining which EM is to perform each directive of the plan and/or replacing general directives by specific directives, as described below.

In some embodiments of the invention, resource governor 212 and/or compiler 200 comprise software codes that run on one or more of execution machines 204. Alternatively or additionally, resource governor 212 and/or compiler 200 run on a separate processor or on two separate processors dedicated for resource governor 212 and/or compiler 200. In this alternative, the compilation may be performed in parallel with the resolution of previously compiled queries without the compilation interfering with the query resolution. An output interface 222 optionally provides command responses as prepared by EMs 204 back to application server 206.

Splitter Operation

FIG. 3 is a flowchart of acts performed by splitter 112, in accordance with an embodiment of the present invention. Splitter 112 optionally receives (300) database access commands from application server 106. If (301) a command is not suitable for execution by accelerator 110, the command is forwarded (302) directly to database server 104. If (301) the command is executable by accelerator 110, splitter 112 determines whether (304) the command is familiar to accelerator 110, for example by comparing the command to a list of familiar commands managed by the splitter. If (304) the command is familiar to accelerator 110, the command is provided (306) to accelerator 110 for execution. If (304), however, the command is not familiar to accelerator 110, the command is optionally provided (308) to database server 104 for execution.

In some embodiments of the invention, if (309) the unfamiliar command relates to data already in in-memory database 120 of accelerator 110, the unfamiliar command is provided (310), in parallel to its being provided to database server 104, to compiler 200 for compilation, in case a similar query is received again by splitter 112, in the near future. Splitter 112 is optionally notified to add (312) the compiled command to the list of familiar commands.

Alternatively or additionally, if (309) an unfamiliar command relates to data already in in-memory database 120 of accelerator 110, the unfamiliar command is passed only to accelerator 110 for compilation and execution. In some embodiments of the invention, this alternative is used in some specific cases, for example, when the load on accelerator 110 is relatively low and/or when the unfamiliar queries are relatively simple. Alternatively or additionally, unfamiliar queries are passed to accelerator 110 when the expected execution time of the query by accelerator 110 is much shorter than by database server 104.

Referring in more detail to determining (301) whether a command is suitable for handling by accelerator 110, in some embodiments of the invention, updates are not handled by accelerator 110. Alternatively or additionally, splitter 112 manages a list of a subset syntax recognized by accelerator 110. Queries including portions not included in the subset syntax are not handled by accelerator 110. Further alternatively or additionally, accelerator 110 only handles commands that relate to certain portions of the database, and commands are considered executable if they only relate to these certain portions of the database. Alternatively, accelerator 110 may handle all portions of the database, and the determination of whether a command is executable is performed irrespective of the data referenced by the command.

In some embodiments of the invention, in comparing (304) queries to the list of familiar queries, the queries are converted to a canonized form that allows better comparison of the queries. Optionally, converting queries into the canonized form includes removing unimportant spaces and tabs and/or combining the interpretation of upper and lower case letters in case-insensitive fields of the commands. In some embodiments of the invention, converting queries into the canonized form includes removing constant values, such that queries that differ only in constant values are considered the same for familiarity and compilation purposes.

In some embodiments of the invention, splitter 112 also manages a list of commands rejected from handling by the accelerator, so that determination time is not repeatedly wasted on rejected claims. Commands in the rejected list are optionally passed only to database server 104 and no determination (309) is performed for these commands on whether they should be passed for compilation (310). Optionally, the list of rejected commands is periodically emptied, for example, each time the contents of in-memory database 120 is changed, as described hereinbelow. The use of the list of rejected commands prevents splitter 112 from repeatedly transferring queries that will probably be determined not to be handled to accelerator 110. Alternatively to preventing queries rejected once from being reviewed by accelerator 110, only queries rejected a predetermined number of times are not referred to accelerator 110. Thus, for example, a query rejected due to a momentary heavy load on one of EMs 204 may be given an additional chance.

Query Confirmation

Optionally, all compiled unfamiliar commands are registered as familiar, after their compilation. Alternatively, after an unfamiliar command is compiled (310), resource governor 212 determines whether the command should be handled, for example, based on the processing resources it requires. A command determined to be handled is referred to herein as being confirmed. Performing the determination after the compilation, provides a more accurate determination of whether to confirm the command, as information from the compilation is available during the determination. Further alternatively or additionally, the required processing resources of the query are estimated before compilation, and accordingly it is determined whether to handle the query before compilation. In this alternative, processing resources are not wasted on compiling non-confirmed commands.

Optionally, the determination of whether to confirm the command is based on the processing resources the command requires, e.g., the processing power, the communication requirements and/or the intermediate memory space. Alternatively or additionally, the determination of whether to confirm the command is made at least partially according to the number of EMs 204 that are required to handle the query.

In some embodiments of the invention, the processing power required by the compiled query is estimated, and the query is confirmed if the required processing power does not exceed a predetermined value. Alternatively or additionally, the query is confirmed if the required processing power is not above a variable threshold, which is a function of the current load and/or expected load of accelerator 110. The current load is optionally determined from the actual utilization of accelerator 110, for example, based on the number of idle cycles of the processors of the accelerator and/or the amount of time queries wait until they are processed. The expected load is optionally determined according to the processing power of the queries familiar to accelerator 110.

Additional methods for determining whether to confirm a command are described hereinbelow, with reference to the confirmation of commands by resource governor 212. In some embodiments of the invention, the same confirmation method is applied to queries handled during the periodic operation of resource governor 212 (described in detail below with reference to FIG. 8) and to queries received from splitter 112 between periodic operations of resource governor 212. Alternatively, different confirmation methods and/or different threshold values are used. For example, for queries received from splitter 112, the processing load on accelerator 110 used in the confirmation determination may comprise the actual load of the accelerator rather than an estimation thereof, as is optionally used by resource governor 212 in its periodic determination. Alternatively or additionally, in order to confirm a query received from splitter 112, a higher or lower expected benefit from the acceleration and/or processing complexity is required than that required in the periodic operation of resource governor 212. A higher expected benefit may be required for queries received from splitter 112, as these queries are common out of turn, as they were not determined to be handled in the regular procedures of resource governor 212. On the other hand, a lower expected benefit may be required for queries received from splitter 112, when these queries may utilize processing power which otherwise would not be utilized.

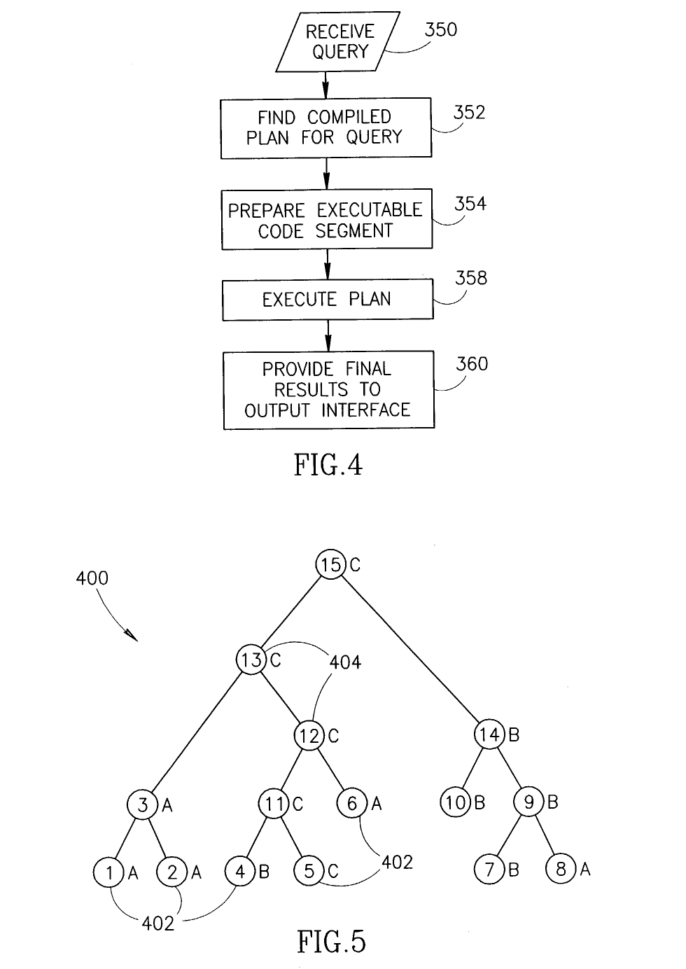

FIG. 4 is a flowchart of acts performed by accelerator 110 on familiar queries received from splitter 112, in accordance with an exemplary embodiment of the present invention. Upon receiving (350) a query from splitter 112, accelerator 110, e.g., dispatcher 206 thereof, optionally finds (352) a previously compiled plan of the query in plan depository 202. The previously compiled plan was optionally prepared under instructions of resource governor 212, as described hereinbelow with reference to FIG. 8. The plan is passed to dispatcher 206, which optionally prepares (354) an executable code segment of the plan (referred to herein also as a colored plan or operational plan), that indicates which execution machines 204 are to resolve the query and in which order the resolution is to be performed. It is noted that, in some embodiments of the invention, the plan resulting from compilation is not directly executable. Before execution the plan is colored by dispatcher 206 which converts the plan into an executable form.

The colored plan is then passed to one or more of execution machines 204 for execution (358). In some embodiments of the invention, if the colored plan includes unrelated portions to be performed by different EMs 204, copies of the plan are passed to a plurality of the EMs 204 in parallel. Optionally, the colored plan includes instructions to each of the EMs 204 which portions of the plan it is to execute and where the different copies of the plan are to be combined.

Each execution machine 204 that completes execution of its portion of the colored plan, optionally passes its intermediate and final results and the colored plan to a different execution machine 204 according to flow statements within the colored plan. Alternatively, the final results are passed to output interface 222 which accumulates the results from the EMs 204 until all the results are received. Alternatively or additionally, in some cases, the execution machine 204 receiving a colored plan, retrieves the data it requires from the memory units 210 of one or more other execution machines 204. The last execution machine 204 in the colored plan optionally provides (360) the final results to output interface 222, which optionally provides the results to application server 106.

As described above with reference to FIG. 3, in some alternative embodiments of the invention, some unfamiliar queries are provided to accelerator 110 for execution. When an unfamiliar query is received by accelerator 110, the query is passed to compiler 200 for compilation, and the resultant plan is passed to dispatcher 206 as described above for plans from plan depository 202.

Compiler Operation and Non-Executable Operators

Referring in more detail to the execution plan prepared by compiler 200, in some embodiments of the invention, preparing the execution plan comprises converting the SQL commands received from application server 106 into a tree of relational operator statements in a language executable by machines 204. Optionally, the execution plan addresses the data it manipulates by a logical name, without being aware of, or relating to, the machine 204 in which the data is stored. Thus, there is no need to recompile a query when the data the query relates to is moved between machines 204. Dispatcher 206, as described below, optionally keeps track of the location of the data and prepares the compiled plans for execution immediately before the execution.

Optionally, in generating execution plans, compiler 200 determines which methods are to be used to execute the command, in a procedure referred to as optimization. The optimization, for example, determines when a sort is to be performed, the order in which a complex join is performed, which indices are to be used and/or any other optimization decisions known in the art. According to the methods selected during optimization, the operator statements of the plan are chosen.

The methods selected during optimization are optionally those that are expected to perform the command using the least processing resources. Alternatively or additionally, the optimization is directed to maximize throughput, response time and/or any other parameter or set of parameters.

In an exemplary embodiment of the invention, the relational operators are either binary operators having two vertical operands or unitary operators having only a single vertical operand. The operator statements are optionally of the form:

X=operator Y [Z] (predicate-list) (projection-list)

in which Y and optionally Z are the vertical operands, X is the resultant vertical, predicate-list is a list of one or more conditions that define which rows are to be carried on to X (according to the specific operator), and projection-list defines the columns included in X and their format. In some embodiments of the invention, the projection list (referred to below as proj) includes for each of the columns of X, the content to be included in that column. Optionally, the content of the column is stated as a function of one or more columns of operands Z and/or Y.

In an exemplary embodiment of the invention, the following operators are employed:

X=SCN Y arbprd proj—X receives the rows of Y that fulfill the conditions of the arbitrary predicate list arbprd.

X=LU Y eqpred [arbprd] proj—X receives rows of Y that fulfill both eqpred and arbprd, where eqpred lists equality predicates and other predicates are included in arbprd.

X=RNG Y rngprd [arbprd] proj—X receives rows of Y that are in the range defined by rngprd and fulfill the predicate list in arbprd—arbprd is optional

X=INFR Y Z arbprd proj—X receives the intersection of Y and Z, (the rows that fulfill the conditions of arbprd), wherein one of Y or Z is a list of row numbers.

X=IRSN Y Z proj—X receives the intersection of Y and Z

X=UNN Y Z proj—X receives the union of Y and Z

X=GVL Y Z proj—X receives the rows of Z, whose numbers are included in a list of row numbers in Y

X=DST Y (cols)—X receives the rows of Y that have distinct values for the columns cols. That is, the rows not included in X have the same values in all of columns cols as at least one other row of Y.

X=TOP Y n—X receives the first n values of Y

X=SRT Y cols proj—X receives Y sorted according to the columns listed in cols. Optionally, the sort list (cols) includes an indication, for each column in the list, of whether the sorting is to be performed ascending or descending.

X=GRP Y Z cols proj—The rows of Y that have the same values in the columns cols are grouped together. The projection-list may include columns also from Z.

X=JOIN Y Z pred proj—X is a table which combines the columns in Y and Z using a join operation, based on pred.

It is noted that the above list of operators is by way of example and many other sets of operators may be used, including fewer or more operators, in accordance with the present invention.

In some embodiments of the invention, the set of operators recognized by executors 204 includes at least one group (referred to herein as a task group) of equivalent operators which perform the same task using different methods. For example, a task group of operators may include a plurality of sorting operators, which use different sorting methods.

In an exemplary embodiment of the invention, EMs 204 recognize the following equivalent look up (LU) operators, which form a look-up task group:

Open hash lookup (LUOH)—uses a hash index of the columns of Y in eqpred.

CS hash lookup (LUCSH)—uses a cache sensitive (CS) hash index of the columns of Y in eqpred.

CS array lookup (LUCSA)—uses a CS array index of the columns of Y in eqpred.

CS-B+Tree lookup (LUCSB)—uses a CS B+ tree index of the columns of Y in eqpred.

Sorted vertical lookup (LUSRT)—assumes Y is sorted according to the columns of eqpred.

The cache sensitive (CS) hash index, the cache sensitive array (CSA) index and the CS B+ tree index are optionally as described in Anastassia Ailamakai, David J. Dewitt, Mark D. Hill, David A. Wood, “DBMSs on a modern processor: Where Does Time Go?” VLDB 1999, pages 266-277; Jun Rao, Kenneth A. Ross, “Making B+ Trees Cache Conscious in Main Memory” SIGMOD Conference 2000, pages 475-486; and/or Jun Rao, Kenneth A. Ross, “Cache Conscious Indexing for Decision-Support in Main Memory”, VLDB 1999, pages 78-89, the disclosures of which documents are incorporated herein by reference.

Other task groups, including a plurality of different equivalent operators, are optionally available for range, sort, group and/or join operators. In an exemplary embodiment of the invention, the task group of “sort” operators comprises a sort-in-place operator, a sort out of place operator and a linear sort operator. Alternatively or additionally, the sort operators comprise a counting sort operator and/or a radix sort operator. In some embodiments of the invention, the EM 204 performing the sort determines at the time of executing the operator, whether there is sufficient space to perform the type of sort of the operator, and if there is not sufficient space, a different type of sort is used.

The “group” operator task optionally includes an operator for sorted data and an operator that uses a hash index. In an exemplary embodiment of the present invention, the “range” operators include an operator that uses a B+ tree, an operator for sorted data, and/or an operator that uses a cache sensitive array. The “join” task group includes, for example, a hash join, an index join, a merge join and/or a nested loop join.

In some embodiments of the invention, when an operator from a task group is required, compiler 200 selects a best operator from the task group of operators, according to one or more parameters of the vertical(s) manipulated by the operator. The selected operator is optionally an operator that is expected to perform the operation at a fastest rate, using a lowest amount of processing power and/or according to any other optimization criteria.

The selection of the specific operator by compiler 200 is optionally performed according to the number of rows in the manipulated columns, the data types of the manipulated columns, the condition of the predicate, the indices available for the manipulated data, the importance of the query and/or the point of execution of the operator within the plan.

It is noted that, in some embodiments of the invention, compiler 200 does not always have accurate estimates of the values required for the selection of the specific operator. For example, the number of rows in an intermediate vertical may not be known. In some embodiments of the invention, the selection of an operator from a task group is performed based on an estimate of the values of the relevant parameters, even if the estimate is not accurate. Optionally, the selection by compiler 200 is only performed if sufficient information is available. Alternatively or additionally, the selection by compiler 200 is performed only if one of the operators of the group is determined to be better than all the other operators of the group by at least a predetermined distinctness. If the selection is not performed by compiler 200, compiler 200 uses a non-executable replaceable directive, as is now described.

Non-Executable Replaceable Directives

In some embodiments of the invention, in some cases, compiler 200 uses a non-executable directive (referred to herein also as an adaptive operator) representing a task group in the compiled plan, instead of using a specific operator from the group. The non-executable directive is later converted into a specific executable operator by the execution machine 204 executing the compiled plan. The EM 204 generally has accurate information on the sizes of the manipulated verticals, and therefore its selection provides more optimal results.

In an exemplary embodiment of the invention, compiler 200 uses a non-executable directive when the size of at least one of the manipulated verticals is not known, e.g., at least one of the verticals is not a base vertical. Alternatively or additionally, compiler 200 uses a non-executable directive when the manipulated vertical does not have an index. Thus, the decision of whether to build a temporary index is postponed to run time.

In some embodiments of the invention, the same considerations are used in selecting specific operators for a task group, irrespective of whether the selection is performed by compiler 200 or by EM 204. Alternatively, different considerations in selecting specific operators are used by compiler 200 and EM 204.

In some embodiments of the invention, the specific operator is selected, during execution, based on the size of the verticals manipulated by the operator and the available memory and/or processing resources of the EM 204 executing the operator. The size of the vertical optionally includes the number of rows in the vertical, the number of columns in the vertical and/or the data types or field lengths of the columns. Alternatively or additionally, the specific operator is selected according to whether the manipulated verticals are sorted and/or according to the type of condition of the predicate of the command. Further alternatively or additionally, the EM 204 selects the specific operator according to the importance of the executed query.

Non-executable directives are optionally available for each of the task groups. Alternatively, non-executable directives are available only for some task groups, i.e., task groups for which optimization data is frequently not available during compilation.

In an exemplary embodiment of the invention, when a plan needs to perform a join on a column that has no indices, compiler 200 uses an adaptive join operator. At run time, the adaptive join is optionally replaced by a nested loop join or by a hash join, which ever has a lower cost. The cost of the nested loop join is optionally determined as n1*n2*MemoryAccessCost, where n1 and n2 are the row counts of the joined tables. The cost of the hash join is optionally calculated as the sum of the cost of building the hash table (HashBuildCost(n1)) and the cost of probing the table (n2*ProbeCost).

Optionally, an adaptive lookup operator is used by compiler 200 when a lookup is required for a vertical not sorted and not having an index that supports the lookup. During run time the adaptive lookup operator is optionally replaced by a simple scan or by an open hash lookup, depending on their costs for the specific vertical referenced by the operator. The cost of a simple scan is optionally calculated as n1*MemoryAccessCost, while the cost of the open hash lookup is optionally calculated as buildcost(n1)+ProbeCost, where ProbeCost is generally negligible.

Optionally, an adaptive range operator is used by compiler 200 when a range scan is required for a vertical not sorted and not having an index that supports the range scan. During run time the adaptive range operator is optionally replaced by a simple scan, by a CSB-Tree range scan or by a sorted vertical range scan, depending on their costs for the specific vertical referenced by the operator. The cost of a simple scan is optionally calculated as n1*MemoryAccessCost. The cost of the CSB-Tree range scan is optionally calculated as the sum of the cost of building the CSB-Tree, the cost of looking up the boundary of the range, and the cost of scanning until the other boundary of the range (or to the last row of the table). The cost of the sorted vertical range scan is optionally calculated as the cost of sorting the table, the cost of looking up the boundary of the range and the cost of scanning until the other boundary of the range (or to the last row of the table).

Alternatively or additionally to representing single operator statements, non-executable directives are used to represent segments of a plurality of operator statements. Optionally, in some cases when during compilation a plurality of operator sequences can be used, compiler 200 generates a plurality of sequences and inserts a directive that represents the task to be performed by the sequences. During the execution, EM 204 selects the sequence to be used, as described above with reference to the directives representing single operators. Alternatively or additionally, the plurality of sequences represented by the directive, include one or more library sequences prepared for general use and not for the specific plan.

Optionally, the plurality of possible sequences are included in the plan provided by the compiler together with the selection conditions. Alternatively or additionally, the EM 204 replacing the directive accesses a segment library in in-memory database 120 to retrieve the selected operator sequence.

In some embodiments of the invention, a directive that represents a plurality of operator sequences is used when compiler 200 cannot determine which sequence is more optimal. Alternatively or additionally, different sequences are generated for different optimization goals, for example throughput and response time. During execution, for example, based on the load on the executing EM 204 and/or the importance of the query, the sequence with the desired optimization goal is selected.

In some embodiments of the invention, a directive that represents a plurality of operator sequences may be used for an entire query. That is, a plurality of plans are generated for the query and the selection of which plan is to be used is performed at the beginning of the execution.

Although in the above description the replacement of the non-executable directive is performed by an EM 204, in some embodiments of the invention, the replacement is performed by dispatcher 206. For example, when a directive represents an entire plan the replacement may be performed by dispatcher 206. Alternatively or additionally, when the replacement is performed according to the importance of the query, the replacement may be performed by dispatcher 206.

Coloring a Plan

Referring in more detail to coloring (354) an execution plan (preparing an execution code segment), in some embodiments of the invention, coloring the execution plan comprises determining for each operator statement of the execution plan which execution machine (EM) 204 is to perform the command. Optionally, dispatcher 206 also adds flow statements to the colored plan. The flow statements optionally instruct the EMs 204 executing the colored plan when to transfer the plan to a different EM 204 for execution and/or what data to transfer to the other EM 204.

FIG. 5 is a schematic illustration of an exemplary execution plan 400, in accordance with an embodiment of the present invention. Execution plan 400 is optionally in the form of a tree that comprises a plurality of internal nodes 404 and leaves 402, which represent operator statements of the execution plan. Each leaf 402 represents a unitary statement which operates on base verticals and does not need to wait for results from other statements. Each of internal nodes 404 represents a binary statement or a unitary statement which operates on intermediate results generated by a different statement (represented by another internal node 404 or by a leaf 402). A binary statement operating only on base verticals is optionally represented by a pair of leaves 402 which represent, respectively, the retrieval of the pair of base verticals, and an internal node 404, which represents the binary statement.

In accordance with the above described embodiment in which each operator references up to two verticals, execution plan 400 comprises a binary tree. For the clarity of the following explanation, each of leaves 402 and internal nodes 404 is marked with a unique number between 1-15 that identifies the statement represented by the internal node 404 or leaf 402. In the following description, the term node is used to encompass both internal nodes 404 and leaves 402.

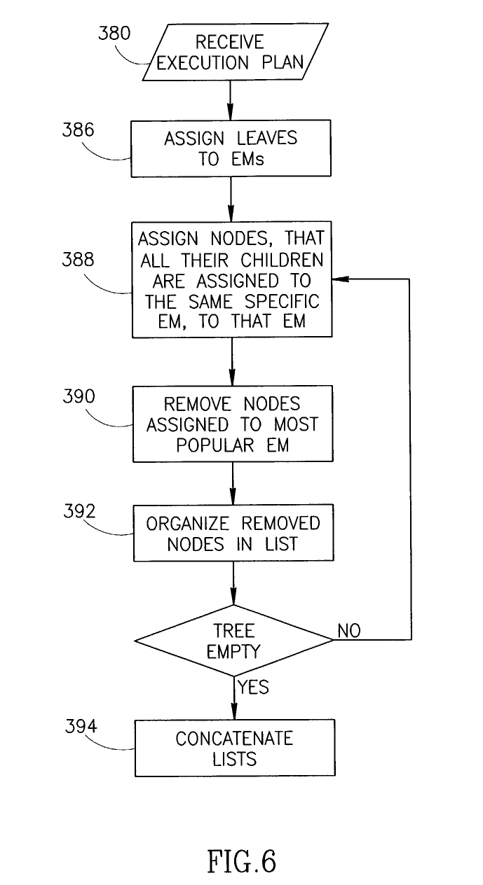

Reference is also made to FIG. 6, which is a flowchart of acts performed by dispatcher 206 in coloring an execution plan, in accordance with an exemplary embodiment of the invention. For each execution plan received (380), each of the leaves 402 of the execution plan (e.g., 400) is assigned (386) to be performed by an EM 204 hosting the vertical manipulated by the unitary operator. In some embodiments of the invention, dispatcher 206 performs the assignment (386) based on a map of the locations of the verticals, managed by in-memory database 120. In the example of FIG. 6, leaves 1, 2, 6 and 8 are assigned to a first executor machine 204A (designated by A in FIG. 5), leaves 4, 7 and 10 are assigned to an executor machine 204B (designated by B) and leaf 5 is assigned to an executor 204C (designated by C).

Optionally, each internal node 404 that all its children are assigned to the same EM 204, is assigned (388) to the same EM 204 as its children. In the example of FIG. 5, node 3 is assigned to executor 204A.

The most popular EM 204, i.e., the EM to which the largest number of nodes are assigned, is optionally determined. The determined EM 204 is then optionally removed (390) from execution plan 400, by removing nodes assigned to the removed EM 204. In the example of FIG. 6, the assigned nodes are nodes 1, 2, 3, 4, 5, 6, 7, 8 and 10. The EM 204 having the largest number of assigned nodes is EM 204A, and therefore nodes 1, 2, 3, 6 and 8 are removed from the tree of execution plan 400. It is noted that the nodes are removed only for the purpose of the coloring process, as all the directives are performed.

In some embodiments of the invention, the statements of the removed nodes are optionally organized (392) into a list for execution by the EM 204 to which they were assigned. Optionally, the statements that do not depend on data from other EMs 204 are organized in the list before statements that depend on data from other EMs 204. In some embodiments of the invention, a migration flow statement is added before operator statements that require data from other EMs 204. The migration flow statement instructs the EM 204 executing the plan to retrieve data it requires from the EM 204 that prepared the data. The migration statement optionally identifies the EM 204 that prepared the data. In the example of FIG. 6, the list of EM 204A includes nodes 1, 2, 3, 6 and 8, all of which represent statements that do not require data from other EMs 204.

The assigning (388) of nodes 404, that all their children currently included in plan 400 are assigned to a single EM 204, to the EM of the children, is optionally repeated after the removal (390) of the nodes of the most popular EM and organization (392) of the statements into a list. This process of removal (390), list organization (392) and assigning (388) is optionally repeated until all the nodes 404 of plan 400 are assigned to a specific EM 204. In the example of FIG. 5, nodes 9 and 14 are assigned to EM 204B, due to the removal of leaf 8. At this point, EM 204B is the most popular EM in plan 400. Therefore, nodes 4, 7, 9, 10 and 14 assigned to EM 204B are removed from the tree of plan 400. The statements of the removed nodes are optionally organized (392) in the following order: 4, 7, 10, 9 and 14, as statements 9 and 14 depend on data from EM 204A. A migration flow statement is optionally added before the statement of node 9.

Responsive to the removal of the nodes assigned to EM 204B, the unassigned nodes in plan 400, namely nodes 11, 12, 13 and 15, are assigned to EM 204C. The nodes assigned to EM 204C are organized, for example, in the following order: 5, 11, 12, 13 and 15. Optionally, migration flow statements are added before each of the statements of nodes 11, 12, 13 and 15.

The lists of each of the EMs 204 are optionally concatenated (394), to form the colored plan.

The above described removal of the nodes assigned to the most popular EM 204, causes the load of the execution plan to be distributed, as much as possible, between the different EMs 204. In some embodiments of the invention, however, other methods are used to determine which nodes are to be removed from the plan. In an exemplary embodiment of the invention, dispatcher 206 randomly chooses an EM 204 whose assigned statements are removed from the plan. Optionally, in randomly selecting the EM 204 whose nodes are removed, more weight is given to EMs 204 having less processing resources, less total or available memory, less communication resources and/or less of any other required resource. Alternatively or additionally, the removed EM 204 is selected as the EM with the highest processing load, the highest memory utilization or a combination thereof.

Alternatively to removing all the nodes of one of the EMs 204, for each node having two children assigned to different EMs 204 one of the children nodes is removed. Optionally, the determination of which child is removed, is performed for each node separately irrespective of the determination for other nodes. In some embodiments of the invention, the determination of which child node is to be removed for a specific parent node, is performed based on the amount of data the parent node needs to receive from each child. Optionally, the parent is assigned to the same EM 204 as the child from which the parent needs to receive the most data. In some embodiments of the invention, the amount of data that needs to be received from each child is estimated based on the number of columns that need to be received. Alternatively or additionally, the amount of data that needs to be received is based on an estimate of the number of rows to be received, for example based on an upper limit of the number of rows in the referenced data. Such an upper limit may be derived, for example, from the base table or base tables from which the data to be transferred is to be generated.

Optionally, when the amount of data transferred from each child is not known and/or when the amount of data is substantially the same (e.g., up to a 5-10% difference) the selection of the removed child is performed arbitrarily and/or based on other considerations. In some embodiments of the invention, the removed child is selected based on the EM 204 to which it is assigned. For example, the removed child may be selected as the child assigned to the EM 204 for which the larger number of nodes was removed.

Conditional Migration Flow

In some embodiments of the invention, instead of removing nodes so that parent nodes will have only children assigned to one EM 204, nodes having children assigned to a plurality of different EMs 204 are marked by dispatcher 206 as being assigned to any of the EMs 204 of their children. During execution, the EM 204 actually to perform the statement of the node is chosen based on the amount of data the statement needs to receive from each of the children nodes and/or the load on the EMs 204. In some embodiments of the invention, such multiple marking of nodes to be resolved during execution is performed for substantially all nodes having children assigned to different EMs 204. Alternatively, only nodes for which dispatcher 206 could not get to a clear cut decision on the assignment, are marked as possibly assigned to a plurality of EMs 204.

Optionally, during execution, when the EM 204 currently performing the colored plan reaches a migration flow statement, the executing EM 204 determines which EM 204 is to execute the following operator statement, based on the amounts of data referenced by the statement. The migration flow statements are referred to in these embodiments as conditional migration flow statements. The conditional migration flow statements are positioned in the colored plans after the operator statements which generate the data used in the conditional migration.

In some embodiments of the invention, the determination of which of the marked EMs 204 is to be used, is performed by determining the amount of data that needs to be received from each EM 204 related to the statement and selecting the EM 204 from which the most data is to be received. Alternatively or additionally, the determination is performed additionally based on the EM 204 to which a brother node (i.e., a node having a common parent node with the current node), if such brother node exists, is assigned.

If the determining EM 204 is to execute the operator statement after the migration flow statement, the EM 204 retrieves the data required for performing the statement from the other EM 204. If, on the other hand, a different EM 204 is to perform the statement, the colored plan is transferred to the other EM 204, along with the data it needs in order to execute the statement. Optionally, retrieving and/or transferring the data includes generating a copy of the data in the intermediate memory area of the receiving EM 204. Optionally, after a vertical is copied the copy of the vertical in the EM 204 from which the data was copied is deleted.

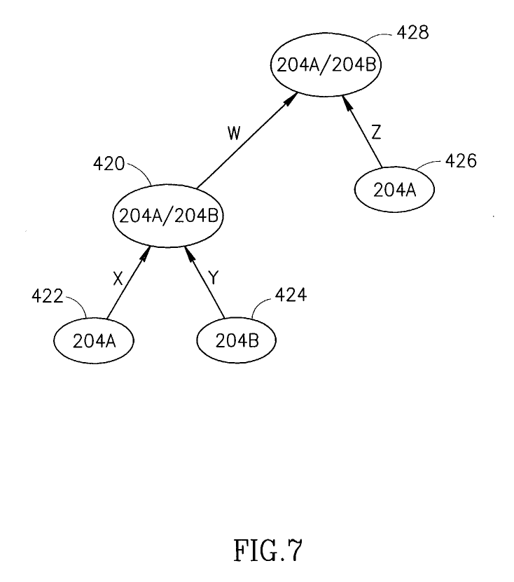

In an exemplary embodiment of the invention, the EM 204 to execute the statement of a multi-EM marked node is selected as is now described with reference to FIG. 7.

FIG. 7 is a schematic illustration of a portion of an execution plan, useful in explaining the selection of an EM 204 to execute a statement, in accordance with an embodiment of the present invention. A node 420 is marked as to be resolved by either of EMs 204A or 204B. A first child node 422 of node 420 is assigned to EM 204A and a second child node 424 is assigned to EM 204B. A brother node 426 is assigned (in FIG. 7) to one of the EMs 204 which may optionally be used to execute the statement of node 420, for example, EM 204A. It is noted that the brother node may have been originally assigned to a specific EM 204 by compiler 200 or the EM to which it is assigned was previously selected during the current execution of the colored plan.

In some embodiments of the invention, in selecting an EM 204 to resolve a statement of a multi-EM marked node 420, it is determined whether the brother node 426 is assigned to a specific one of the EMs 204, which node 420 is marked as possibly resolved thereby. If the brother node 426 is not assigned to a specific EM 204 or is assigned to an EM 204 which is not marked as optional for resolving the statement of node 420, the determination of the EM to resolve the statement of node 420 is performed, as described above, without relation to brother node 426. If, however, the brother node 426 is assigned to one of the EMs 204 marked as optional for resolving the statement of node 420, the amount of data received by node 420 from each of its children (X,Y) is determined, in addition to an estimate of the amount of data provided by node 420 (W) and brother node 426 (Z) to their parent node 428. The amount of data (W) provided by node 420 to parent node 428 is optionally estimated base on the amount of data (X,Y) received from its children nodes, using any estimation method known in the art.

The amount of data which will need to be transferred between EMs 204 for both of nodes 420 and 428, for each of the possible EMs 204 which may execute the statement of node 420 (e.g., listed in the conditional migration command), is optionally determined. The EM 204 that requires the least transfer of data is optionally selected. In the example of FIG. 7, EM 204A is selected for node 420, if Y<X+min (W, Z).

Colored Plan Cache

In some embodiments of the invention, dispatcher 206 manages a cache of colored plans. Colored plans from the dispatcher cache may be used as long as the locations of the verticals manipulated by the plan did not change between memory units 210. Optionally, when a vertical is removed from memory units 210 or the location of a vertical is moved from one memory unit 210 to another, dispatcher 206 removes from the dispatcher cache, colored plans relating to the vertical. Alternatively or additionally, each plan in the dispatcher cache and/or each location map of data in in-memory database 120 is associated with a time-stamp. Before using a colored plan from the dispatcher cache, dispatcher 206 checks that the time-stamp of the location map is older than the time-stamp of the plan.

Optionally, if a colored plan includes one or more nodes marked with a plurality of EMs 204, dispatcher 206 attempts to assign the node to a specific EM 204 based on the sizes of the data referenced by the non-assigned operator statements. Alternatively or additionally, after the colored plan is executed, the EMs 204 that executed the statements are planted into the colored plan for its next execution. In some embodiments of the invention, the assigning of statements to a specific EM 204 is performed based on data from a plurality (e.g., 3-5) of executions. Optionally, the assigning is performed only if the same EM 204 was selected in all the executions of the colored plan, or in a great majority of the executions.

Use of Coloring Sets

In some embodiments of the invention, as described below, copies of a single vertical may be hosted by a plurality of EMs 204. In some of these embodiments, dispatcher 206 receives a list (referred to herein as a coloring set) of the EMs 204 to be used for each of the duplicated verticals together with the compiled plan. An exemplary method of generating the coloring set by resource governor 212 is described hereinbelow. Alternatively or additionally, the coloring set lists the EM 204 to be used for some or all of the verticals hosted by only a single EM 204, for example in order not to require that the dispatcher 206 consult in-memory database 120.

In some embodiments of the invention, an execution plan is associated with a plurality of alternative coloring sets. Dispatcher 206 optionally selects one of the coloring sets which has a lowest execution cost. For each coloring set, dispatcher 206 optionally calculates the products of the costs of the operator statements of the plan and the load on the respective EMs 204, which are to perform the operator statements according to the coloring set. Optionally, the products are calculated only for operator statements that reference data in at least one of the coloring sets. The execution cost for each coloring set is optionally calculated as the sum of the calculated products, i.e., coloring set load=Σ{load (EM)*cost(statement)}.

Alternatively or additionally to receiving coloring sets, dispatcher 206 performs the tasks of generating the coloring set, described herein below, before coloring the plan.

Referring in more detail to determining a cost for each operator statement, in some embodiments of the invention, the cost is determined by compiler 200 and provided to dispatcher 206 with the execution plan. Alternatively, the cost is determined by dispatcher 206. Further alternatively, the cost is not used at all by dispatcher 206 and selection of one of a plurality of coloring sets is performed arbitrarily, randomly and/or using any other simple method. Using this alternative simplifies the operation of dispatcher 206 although at the possible cost of achieving a less optimal colored plan.

In some embodiments of the invention, the complexity of dispatcher 206, and hence the optimality of the colored plans, may be adjusted by a system manager according to the specific needs of the system and/or based on overall optimality tests. Alternatively or additionally, the complexity of dispatcher 206 is dynamically adjusted responsive to the respective loads on EMs 204 and dispatcher 206.

Determining Cost of Operator Statement

In some embodiments of the invention, the cost of an operator statement is equal to the processing power required by the operator statement. Optionally, the required processing power is a function of the complexity of the operator of the statement. For example, sort operators may have a higher required processing power than join operators. Alternatively or additionally, the required processing power of an operator statement is a function of the size of the verticals manipulated by the statement and/or the complexity of the predicate list and/or projection list of the statement.

In an exemplary embodiment of the invention, the required processing power of an operator is a function of the number of memory accesses it performs, assuming that the cost of calculations are negligible. For example, required processing power of a scan operator is equal to the number of rows (N) scanned. The required processing power of a nested join is optionally N1*N2, where N1 and N2 are the row numbers of the joined tables. The required processing power of a cache sensitive array (CSA) look-up operator is, for example, Log2N/Log2(M+1), where N is the number of rows in the referenced vertical and M is the number of keys held in a single cache line (e.g., M=4).

Collection of Statistics by Splitter

In some embodiments of the invention, splitter 112 keeps track of the queries passing through the splitter in order to provide resource governor 212 with information on the types of queries handled by database access system 100. Optionally, for each query, splitter 112 keeps track of the number of times the query was received during a predefined time period, i.e., the popularity of the query. In some embodiments of the invention, for each query, splitter 112 keeps track of the response time of the query i.e., the time until an answer to the query was received, from accelerator 110 and/or from database server 104. Splitter 112 optionally keeps track of the average response time over the last predefined time period. In some embodiments of the invention, splitter 112 also keeps track of the sizes of the results of the queries.

In some embodiments of the invention, splitter 112 periodically transmits queries that can be resolved by accelerator 110, to database server 104, in order to determine the response time of database server 104 relative to the response time of accelerator 110. Optionally, each query is transmitted at least once every predetermined interval (e.g., 5-10 minutes) to database server 104, even if the query is familiar to accelerator 110. In some embodiments of the invention, splitter 112 stores in the list of familiar queries, the last time the response time of database server 104 was determined for each of the queries in order to facilitate the timely transmission of queries to database server 104.

Resource Governor Operation

FIG. 8 is a flowchart of the acts performed by resource governor (RG) 212, in accordance with an embodiment of the present invention. Resource governor 212 optionally continuously receives (500) statistics on the queries handled by system 100, from splitter 112 and/or from elements of accelerator 110. For example, resource governor 212 may receive information on resources consumed by the plans they execute from EMs 204. At predetermined time points, RG 212 forms (502) a roster of recently received query statistics to be used in determining the data contents to be loaded into memory units 210.

The roster of queries is optionally grouped (504) into a plurality of clusters of related queries. A score, representative of the worth of handling the queries of the cluster by accelerator 110, is optionally assigned (506) to each of the clusters. A cluster with a best score is optionally selected (508). In some embodiments of the invention, resource governor 212 determines (515) how the tables referenced by queries of the selected cluster are to be decomposed into verticals. Resource governor 212 optionally determines (514) which indices are to be created for the database portions accessed by the queries of the selected cluster. Optionally, the indices are selected after the decomposition of the verticals. In some embodiments of the invention, each index is selected for a specific vertical. Alternatively, the indices are selected for specific columns. In some embodiments of the invention, a single vertical may have a plurality of indices for different columns of the vertical.

In some embodiments of the invention, the queries of the selected cluster are passed (510) to compiler 200 for compilation, optionally only if not previously compiled.

The resources required for handling the commands of the selected cluster by accelerator 110 are optionally estimated (519). If (516) accelerator 110 has resources beyond those required for already selected clusters, the scores of the other clusters are optionally corrected (518) responsive to the selection of the recently selected cluster and a non-selected cluster with a best score is selected (508). The above described acts (515, 514, 519) are optionally repeated for the additional selected cluster. When (516) clusters that utilize substantially all the available resources of accelerator 110 were selected, resource governor 212 optionally determines (522) the placement of the verticals and indices of the selected clusters in in-memory database 120, i.e., in which of memory units 210 each of the verticals and indices is to be positioned. In some embodiments of the invention, the placement determination (522) is performed after the compilation of all the selected queries is completed.

Thereafter, accelerator 110 updates (524) the contents of in-memory database 120 according to the determination. In addition, the list of familiar queries in splitter 112 is updated (526).

The Roster

Referring in more detail to forming (502) the roster of queries, in some embodiments of the invention, the roster includes queries collected between the point in time at which the roster is formed and the previous point in time at which a roster was formed. Alternatively, the roster includes queries taken into account in previous rosters. In some embodiments of the invention, queries taken into account in forming previous rosters are given less weight than queries collected after the formation of the previous roster. In an exemplary embodiment of the invention, query occurrences appearing in previous rosters are counted as appearing half the times they actually were received by splitter 112.

In some embodiments of the invention, substantially all the queries received during the period used in forming the roster are included in the roster. Alternatively, only queries relating to predetermined portions of the database, received from predetermined users and/or having at least a predetermined importance level are taken into account in forming the roster. Further alternatively or additionally, the roster is set to include up to a predetermined number of queries. When the number of received queries exceeds the predetermined number, queries are excluded arbitrarily and/or according to any of the above mentioned criteria. In some embodiments of the invention, only queries which have at least a predetermined popularity (i.e., were received at least a predetermined number of times) are included in the roster. Optionally, queries familiar to accelerator 110 are not excluded from the roster or are given preference to being included in the roster.

In some embodiments of the invention, the roster includes an indication of the popularity of each query and whether the query is currently familiar to accelerator 110. Optionally, the roster includes response times of the queries (as described above with reference to collection of statistics by the splitter) and/or resource requirements of the queries. The resource requirements of the queries optionally include the memory required for the base tables manipulated by the queries, the amount of memory required for intermediate results and/or the processing power required for resolving the queries. Alternatively or additionally, some or all of the above listed accompanying data is determined separately and/or at a later time, by resource governor 212.

Optionally, for each query, a query access needs (QAN) data structure, that summarizes data on the base columns referenced by the query, is prepared. The QAN optionally lists, for each referenced data column, the access type (as described in detail below) used by the query to access the column.

Clustering

Referring in more detail to grouping (504) the queries of the roster into clusters, in some embodiments of the invention, the queries are clustered according to the columns and/or tables to which the queries relate, such that queries in the same cluster relate generally to the same or similar columns and/or tables and optionally use same or similar indices.

Optionally, each cluster includes queries that relate to verticals which occupy up to a maximal memory size. In some embodiments of the invention, the maximal memory size is such that all the verticals referenced by queries of the cluster can fit into a single memory unit 210. Alternatively or additionally, each cluster includes queries that together require up to a predetermined maximal processing power. Further alternatively or additionally, each cluster includes queries with up to a maximal required communication capacity.

The communication requirements of a cluster are optionally determined as a sum of the communication requirements of the queries of the cluster. Optionally, the communication requirements are measured in terms of bytes per second (bps). In an exemplary embodiment of the invention, the communication requirements of a query are equal to an estimate of the size of the query results (in bytes) times the number of times per second the query is expected to be received by accelerator 110.

In some embodiments of the invention, each query is included in only a single cluster so that queries are not handled twice or more by resource governor 212. Alternatively, some queries are included in a plurality of clusters, and when a cluster to which the query belongs is selected, the query is removed from the other clusters.

In some embodiments of the invention, a distance function d(q1,q2) between queries q1 and q2, which provides a value indicative of the suitability of the queries to be in the same cluster, is defined. The distance function d(q1,q2), for example, is linked to the number of verticals referenced by both the queries q1 and q2 and/or to the total number of verticals referenced by only one of the queries. Optionally, the distance function is also a function of the access type used by the queries to the verticals referenced by both the queries. Giving weight in the distance function to the access type makes the distance between queries expected to use same indices smaller, as the indices are linked to the access types. In some embodiments of the invention, the distance function gives a first weight to queries accessing a common column with different access types and a second, higher, weight to queries accessing the common column with the same access type. Optionally, the distance between any two access types (e.g., lookup, range, order, grouping, string matching, equi-join) is substantially the same. Alternatively, groups of access types which are similar (referred to hereinbelow as primary access types) are defined and the distance between access types of different primary access types is larger than the distance between different access types within a single primary access type. The distance between different access types within a single primary access type may be low but still existent or may be zero, as in most cases queries of the same primary access type will use the same index.

In some embodiments of the invention, the distance function, for a specific column, takes into account the column groups in which the column is referenced by each of the queries. For example, two queries that access a specific column as part of a same group of columns are considered closer, with respect to the specific column, than two queries that reference the specific column as part of different groups (e.g., one query references the specific column alone while the other query references the specific column along with other columns).

In an exemplary embodiment of the invention, each of the queries for which the distance is calculated (q1 and q2) is represented by a vector of the sizes (e.g., number of rows) of the searched and projected columns accessed by the query. The distance function is calculated as a vector distance between the vectors, such that columns accessed by both queries do not contribute to the distance, and columns accessed by a single query contribute their size. Optionally, the square vector distance is used. Alternatively or additionally, any other vector distance is used, such as the absolute value distance.

Alternatively to the vectors having an element for each column accessed, the vectors have an element for each pair formed of (1) a column accessed by the query represented by the vector and (2) the access type used by the query to access the column. In some embodiments of the invention, instead of each vector element receiving the size of the column represented by the vector element, a fixed value is given for each existent column.

In some embodiments of the invention, instead of having a vector element for each column accessed by the query (or for each column and access type), vector elements are given to each group of one or more columns accessed by a fragment of the query. That is, a group of columns accessed together are optionally related to separately (e.g., have a separate vector element) from each of the columns separately.

In an exemplary embodiment of the invention, the distance function d(q1,q2) is a weighted function of a data distance function data(q1,q2) and an access distance function access(q1,q2), for example as in:

d(q1,q2)=data(q1,q2)+w*access(q1,q2)

in which w is a weight smaller than 1, so that the access distance is less dominant than the data distance. The data distance function is optionally equal to the space required for all the data accessed by only one of q1 or q2 (referred to herein as xor(q1,q2)) divided by the space required to store all the data accessed by at least one of q1 and q2 (i.e., union(q1,q2)). In some embodiments of the invention, xor(q1,q2) is calculated according to

xor=union(q1,q2)−and(q1,q2),

where and(q1,q2) is the space required by data accessed by both q1 and q2.

In calculating the function access(q1,q2), each pair of a column and access type to the column is considered separately. A total_access(q1,q2) function is optionally equal to the sum of the storage space of the columns accessed by at least one of q1 and q2 in which each column is counted for each access type used by at least one of q1 and q2 in accessing the column. A common_access(q1,q2) function is equal to the sum of the storage space of each column accessed using the same access type by both q1 and q2, the space of each column being added once for each access type used by both q1 and q2 in accessing the column. Optionally, access(q1,q2) is give by:

access(q1,q2)=[total_access(q1,q2)−common_access(q1,q2)]/total_access(q1,q2)

In some embodiments of the invention, the appearance of columns in projection portions of queries is not taken into account in calculating access(q1,q2), as columns appearing only in projections do not necessarily need to be cached.

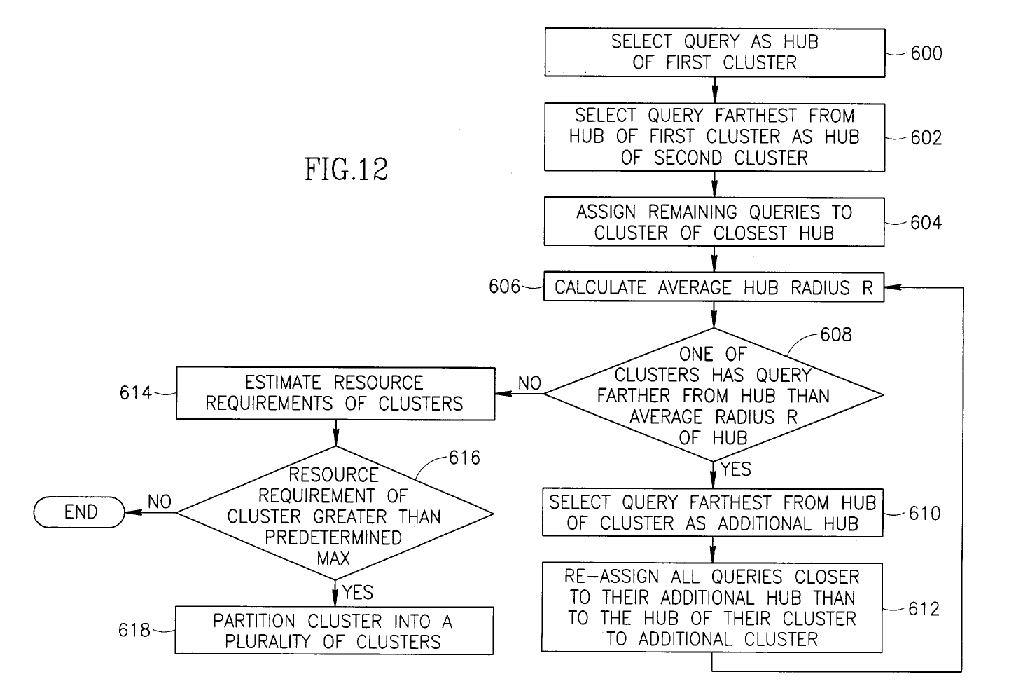

Exemplary methods for grouping the queries into clusters are described hereinbelow with reference to FIG. 12.

Cluster and Query Score

Referring in more detail to assigning (506) a score to each of the clusters, in some embodiments of the invention, the cluster score is a function of a resource score, a contribution score and/or a proximity score. The resource score optionally represents the resources required to resolve the queries of the cluster and the contribution score optionally represents the expected acceleration if the cluster is cached. The proximity score optionally represents the resources required to prepare the accelerator for handling queries of the cluster, given the current content of the accelerator memory.

Resource Score

The resource score is optionally a function of the amount of memory required for resolving the queries of the cluster. Assuming, without loss of generality, that the highest score is considered the best score, the score of a cluster optionally increases as the memory requirements of the queries of the cluster decrease. Having accelerator 110 handle queries with low memory requirements generally allows the accelerator to handle a larger number of queries.

Alternatively or additionally, the resource score is a function of the processing power required by the queries of the cluster. Optionally, the processing power required for a query is calculated as the sum of the processing powers required by the operator statements of the plan of the query. Optionally, as the processing power requirements of the queries of the cluster decrease, the score of the cluster increases. Having accelerator 110 handle queries with low processing power requirements allows the accelerator to handle a larger number of queries. Alternatively, a higher score is given to clusters which have higher processing requirements so that accelerator 110 takes over from database server 104 queries with heavy processing requirements. Further alternatively, a higher score is given to clusters whose queries require processing power matching the memory resources required by the queries. In this alternative, the processing power of the queries is matched to the memory resources of the queries in order to maximize the utilization of the resources of accelerator 110.

Further alternatively or additionally, the resource score is a function of the stability of the verticals referenced by the cluster, i.e., the rate at which the data in the vertical needs to be refreshed. In some embodiments of the invention, a higher score is given to clusters which relate to relatively stable verticals, so that the amount of resources required to handle updating the cached copies of the verticals in in-memory database 120 is relatively low. Optionally, the stability level of verticals is determined based on the number of update commands, which relate to the table, passing through application server 106. Alternatively or additionally, the stability level of tables is determined based on the number of times back end unit 114 receives update notifications from database server 104, for the table.

Optionally, back end unit 114 keeps track of the stability of one or more tables not currently cached by in-memory database 120, in order to determine their stability level. In some embodiments of the invention, back end unit 114 keeps track of the stability of all the tables in storage disk 102, in order to have full stability data. Alternatively, back end unit 114 keeps track only of the stability of tables cached in accelerator 110, in order to limit the processing power required by back end unit 114. In some embodiments of the invention, back end unit 114 keeps track of the stability of a portion of the database not cached by accelerator 110, the size of which is determined as a compromise between achieving accurate data and requiring minimal resources from back end unit 114. Optionally, the portions for which back end unit 114 monitors stability include portions previously cached, portions referenced by clusters having a relatively high score but not selected, preconfigured portions and/or portions determined by any other method, to have a relatively high chance to be cached.

In some embodiments of the invention, the stability level of a vertical gives equal weight to deletion, insertion and updates of rows of the vertical. Alternatively, different weight is given to deletion, insertion and update occurrences according to the specific resources required to handle these update occurrences. Contribution score In some embodiments of the invention, the contribution score is a function of the difference between the response time of database server 104 and of accelerator 110, for the queries of the cluster. Optionally, higher scores are given to queries for which accelerator 110 has a faster response time than database server 104. Alternatively or additionally, the contribution score is a function of the popularity of the queries of the cluster. Optionally, a higher score is given to queries that are more popular in the query roster. In an exemplary embodiment of the invention, the contribution score is proportional to the popularity of the query multiplied by the difference between the accelerator response time and the response time of database server 104.

In some embodiments of the invention, the contribution score is a function of the importance of the queries (e.g., the QoS of the queries) of the cluster.

The most recent response times recorded by splitter 112, for database server 104 and accelerator 110, are optionally used in determining the contribution score. Alternatively, an average response time determined for a plurality of measurements is used. The average is optionally determined for queries passing through splitter 112 over a predetermined time and/or for up to a maximal number of queries.

In some embodiments of the invention, response times recorded for identical queries are used. Alternatively, for each query, the response times recorded for substantially identical queries (e.g., queries different in only constants) are used. Further alternatively or additionally, the response times recorded for similar queries (e.g., relating to the same data tables, having substantially the same length, having the same conditions), are used.

In some embodiments of the invention, when a response time for a query is available only for database server 104, the response time is compared to an expected and/or average response time for the query. The contribution score is optionally determined according to the difference between the measured response time and the expected and/or average response time.

Proximity Score

In some embodiments of the invention, the proximity score is a function of the number of queries in the cluster not already handled by the accelerator. Alternatively or additionally, the proximity score is a function of the number and/or sizes of data columns referenced by queries of the cluster that are not in in-memory database 120. Optionally, a higher score is given to clusters that include queries that are already currently handled by accelerator 110. Further alternatively or additionally, the proximity score is a function of the number of indices that were already built for data referenced by the queries of the cluster. Further alternatively or additionally, the proximity score is a function of the cost of compiling the query if not yet compiled.

Optionally, after start-up, before a large number of queries were accumulated, low weight, or even no weight, is given to the proximity score, in the cluster score. This low weight prevents accelerator 110 from locking onto a data group which achieves a local maximum in the optimality of accelerator 110, rather than striving for a global maximum. Alternatively or additionally, periodically (for example once every 40-60 determinations), a score giving low weight to the proximity score is used, in order to prevent accelerator 110 from settling in a local optimum which is not optimal globally.

Score Determination

Optionally, each query is assigned a score and the cluster score is calculated as the sum of the scores of the queries included in the cluster. Alternatively, the scores are calculated directly for the clusters.

It is noted that, in some embodiments of the invention, the score is determined for at least some of the clusters before the queries of the cluster are compiled, for example for queries not currently familiar to accelerator 110. Additionally, other information required for determining the scores may be missing for some of the queries. In some of these embodiments, the score determination is optionally performed using measures which do not require compilation of the queries for their determination, for example the popularity of the query. Alternatively, the score determination uses measures that require compilation of the queries for their actual determination, but for non-compiled queries an estimate of the measure is used. For example, a predetermined value may be used as the estimate. Further alternatively, at least some of the queries are compiled before they are selected, in order that information from the compilation can be used in determining their score.

In an exemplary embodiment of the invention, the score is provided in time units. For example, the proximity score optionally states a time required to prepare for a new query and/or the contribution score states a time expected to be saved for the accelerated queries.

In an exemplary embodiment of the invention, the cluster score is given as:

$$score ( C ) = \frac{( {\sum }_{i ∈ C} P ( i ) * Δ ( i ) ) - update ( C )}{memory ( C )}$$

in which C is the cluster, score(C) is the cluster score, i runs over the queries of C, P(i) is the popularity of query i, Δ is the difference between the response time of database server 104 and accelerator 110 for query i, update(C) is the cost of accepting a new query and memory(C) is the amount of memory required for the cluster. Optionally, update(C) is zero for queries already familiar to accelerator 110.

In an exemplary embodiment of the invention, update(C) is given by:

$$update ( C ) = {\sum }_{j ∈ C} up\_freq ( j ) * up\_cost ( j ) + Load\_cost ( j )$$

in which j runs over the columns referenced by C, up_freq(j) is the average rate at which column j is updated, up_cost(j) is the time required to update a value in column j and Load_cost(j) is the cost of loading column j into in-memory database 120. Optionally, verticals j already selected by previously selected clusters are not included in the calculation of update(C).

In some embodiments of the invention in which the score determination for non-compiled queries uses estimated values for one or more measures used in determining the score, the assigned score is revisited after the compilation in order to evaluate the estimation. Optionally, the method of estimation is dynamically adjusted according to the evaluation of the estimation.

In some embodiments of the invention, a query may have a plurality of compiled plans. In these embodiments, separate scores are optionally determined for each plan. Optionally, the score of the query is the average or the maximum of the scores of the plans of the queries. Alternatively or additionally, the plan used is selected according to the mode of operation of accelerator 110 and the score given is of the selected plan.

Comparing Different Scores

In some embodiments of the invention, resource governor 212 determines a plurality of different scores using different score functions for the clusters. Optionally, according to the relation between the different score sets, a score set to be used in selecting clusters is chosen. In an exemplary embodiment of the invention, two score sets are generated, one according to a function which takes the proximity into account and the other according to a function that does not take the proximity into account. If the difference between the scores with and without the proximity attribute is relatively small, the score with the proximity attribute is used in order to take advantage of the familiarity of accelerator 110 to some of the data.

If, however, the difference between the scores is relatively large, the proximity score may be forcing accelerator 110 into a non-optimal local maximum. Optionally, therefore, the score which does not take proximity into account is used. Alternatively, a predetermined number of tables and/or verticals, which would be removed from in-memory database 120 if the score which disregards proximity were used, are determined to be removed from in-memory database 120, in order to force accelerator 110 to leave the local maximum. In other embodiments of the invention, a predetermined percentage of the tables and/or verticals which would be removed according to the score that disregards proximity, are determined to be removed from in-memory database 120. The score which takes proximity into account is optionally recalculated, taking into account that the verticals and/or tables to be removed from in-memory database 120 are being removed. The results of this score are then used in selecting clusters and determining which verticals are to be loaded into accelerator 110.

In some embodiments of the invention, the calculation of the plurality of scores is performed each time resource governor 212 performs the method of FIG. 8. Alternatively, the calculation of the plurality of scores is performed periodically, for example, every 5-10 times the method of FIG. 8 is performed. Thus, the processing power required for producing the score sets is reduced, while still preventing a long term settling in a local maximum.

Alternatively to assigning scores to clusters and accordingly deciding which queries are to be cached, each query is assigned a separate score and the queries with the highest scores are selected for handling by the accelerator. Thereafter, the selected queries are optionally clustered. In this alternative, the most important queries are selected for acceleration, although possibly at the cost of efficiency in selecting the queries, as the relation of different queries to the same data is not directly taken into account. Indirectly, however, queries relating to the same data would generally receive similar scores, as many of the score factors would have similar values for queries relating, at least partially, to the same data.

Referring in more detail to correcting (518) the scores of the non-selected clusters, in some embodiments of the invention, the scores are corrected under the assumption that the database portions required for resolving the selected queries are already in the memory. Thus, queries that use data verticals and/or indices which appear in a selected cluster are given a higher score than they were assigned earlier.

In some embodiments of the invention, if a cluster has a score greater than the score of a previously selected cluster, according to the above equation, the score of the cluster is set equal to the score of the previously selected cluster or to a value smaller thereof, so that the scores of the selected clusters decrease (or do not increase) with the order of selection. This is optionally performed when the cluster score is used for tasks other than the selection of clusters, for example for determining the amount of memory is used for indices of the cluster. In some embodiments of the invention, the scores of the specific queries of the clusters are not changed.

Vertical Partitioning

Referring in more detail to determining (515) the partitioning of tables into verticals, in some embodiments of the invention, the tables are partitioned as much as possible. That is, unless specifically required, as is now described, each column is stored in a separate vertical in in-memory database 120. The use of smaller verticals, generally allows faster processing of the verticals.

Multi-column verticals are optionally generated when the cluster includes a query that has conditions on multiple columns of a table. For such queries, resource governor 212 optionally determines that all the columns referenced by the condition of the query are included in a single vertical. Alternatively or additionally, columns that are not included in conditions of any of the queries of the clusters but are included in projections (if they are not referenced at all they are not cached), are included with at least one other column in a single vertical. Further alternatively or additionally, when a composite key is used to reference a table, all the columns referenced in the composite key are included in a single vertical.

In some embodiments of the invention, verticals that are not identical do not include common columns. That is, no partially overlapping verticals are created, in order to conserve memory space. In these embodiments, large verticals may be required, for example, when two different queries require a first column to be in the same vertical as second and third columns, respectively.

Alternatively, when expected to achieve more optimal operation, partially overlapping verticals are created, for example, when a table is expected to be sorted according to different composite keys. Further alternatively or additionally, small columns that are accessed by relatively popular queries are duplicated, for example once alone and once with other columns. Further alternatively or additionally, a column is included in a plurality of verticals to prevent a vertical width (i.e., the accumulated sizes of the data types of the columns included in the vertical) from exceeding a predetermined width. The predetermined width may include, for example, a largest width that allows efficient use of the cache.

In some embodiments of the invention, the vertical decomposition attempts to decompose tables in the same manner as used for the data currently cached by accelerator 110. Optionally, in determining whether to combine columns into a single vertical and/or whether to include a column in more than one vertical, weight is given to the form in which the columns are currently cached in in-memory database 120, if the columns are already cached.

An exemplary method for determining which columns should be cached in more than one vertical is now described with reference to FIG. 9. Other methods will be evident to those skilled in the art.

FIG. 9 is a flowchart of acts performed in vertical decomposition of tables referenced by a cluster, in accordance with an embodiment of the present invention. The queries of the cluster are optionally scanned for queries that perform a single operation on groups of a plurality of columns of a table. The groups of columns referenced by these queries are optionally listed (530) in a group of candidate multi-column verticals (CV) per table. In some embodiments of the invention, only groups of columns referenced by queries having together at least a predetermined query score (e.g., as a sum of their query scores, or as a maximum of their scores) are included in the group of candidate multi-column verticals (CV). Such columns are referred to herein as high importance columns, while columns referenced by queries with a combined low score are referred to as low importance columns. In these embodiments, queries referencing low importance columns are optionally removed from the cluster, so as not to require the caching of a multi-column vertical with a low importance score.

The candidate multi-column verticals in CV belonging to the table are optionally examined (532) for columns included in a plurality of candidate verticals, referred to herein as common columns. Optionally, the CVs are grouped according to the tables to which they belong and the examination is performed for each table separately, as all the columns of a vertical belong to a single table.

For each pair of CVs having a common column, which is not marked (in both CVs) to be duplicated, resource governor 212 optionally determines a duplication score of the common column, which score is indicative of the importance of caching the common column twice. Optionally, if (534) the duplication score is above a predetermined threshold, the common column is marked (535) to be duplicated in both the CVs. If (534) the duplication score is beneath the predetermined threshold, the pair of candidate verticals are combined (536) into a single CV. Alternatively or additionally, if the columns of one of the candidate verticals has a low importance score, the low importance candidate vertical is removed from consideration. The queries that require the low importance multi-column candidate vertical which is removed from consideration, are removed from the cluster.

The determination of whether there are common columns is optionally repeated until (533) all the common columns of candidate verticals in the list are marked as being duplicated. The resultant set of candidate verticals, together with single column verticals for verticals not in the set, is optionally the result of the vertical decomposition.

In some embodiments of the invention, for each table processed, if the key column of the table is not referenced by any of the queries of the cluster, a vertical of the key column is also indicated to be created (although it itself is not needed). The creation of the key column vertical along with verticals of other columns of the table, in the same cluster, allows for high chances that the key column vertical will be cached in the same memory unit 210 with the other columns of the table, as verticals of a single cluster are generally cached in the same memory unit 210. The caching of the key column vertical with the other columns of the same table in the same memory unit simplifies the updating of the contents of the verticals when there are changes in the table on disk 102. Alternatively, to caching the key column of all tables along with other columns of the table, the key column is cached although it is not needed by the queries of the cluster, only when the table has a relatively low stability rating (i.e., it is frequently refreshed).

In some embodiments of the invention, the examination (532) of the candidate multi-column verticals for columns included in a plurality of candidate verticals, is performed by repeatedly selecting a first candidate vertical of the table and finding a second candidate vertical, of the same table, that has at least one common column with the first candidate vertical. If (533) such a second candidate vertical is not found, the first candidate vertical is marked final and is not compared to other candidate verticals.

Referring in more detail to the duplication score of a column, in some embodiments of the invention, the duplication score is a function of the width and/or length (i.e., number of rows) of the column, such that larger columns have a lower chance to be duplicated. Alternatively or additionally, the duplication score depends on a column score, which represents the popularity of queries that reference the column. The duplication score optionally increases as the column score increases. In some embodiments of the invention, the column score is a sum of the scores of queries referencing the column. Alternatively or additionally, the column score is the same as described below with reference to the index selection. Further alternatively or additionally, the duplication score depends on the types of indices available for the column and/or on the access types of queries that access the column. Optionally, columns that are accessed by inequality operators receive higher scores, as the importance of not having long lines, due to the combining of candidate columns, is greater. In an exemplary embodiment of the invention, columns that are not accessed by at least one inequality operator receive a zero duplication score, so as to save the memory area assigned to duplication for inequality operators which may serially review the rows of the columns. Alternatively or additionally, when the columns of the first and second candidate verticals are accessed only in projections, the duplication score is low or zero.

In some embodiments of the invention, the duplication score of a column common to first and second verticals is a function of the combined width of a vertical combined from the first and second candidate verticals. Optionally, if the combined width is lower than the cache line length of one or more of EMs 204 the duplication score is given a low value, as the combination of the verticals does not impede the processing speed.

In some embodiments of the invention, different EMs 204 have different cache line lengths. Optionally, in these embodiments the combined width of the first and second verticals is compared to the lowest cache line length of any of EMs 204, so that a column that receives a low duplication score due to the combined width being low, will fit to the cache line length of any EM 204 assigned to handle the verticals. Alternatively or additionally, the effect of the combined width of the first and second candidate verticals on the duplication score is in the form of a step function, in which the steps follow the cache line lengths of EMs 204. Optionally, the effect on the duplication score depends on the chances that the combined vertical will enjoy the advantage of being smaller than the cache line length, if the candidate column is processed arbitrarily by any of EMs 204.

In some embodiments of the invention, an amount of duplication space for duplication of verticals for the cluster is determined. If the columns already selected for duplication, with regard to the current cluster, utilize substantially all the duplication space, the candidate verticals are combined regardless of the duplication score. Alternatively, the predetermined threshold value, to which the duplication score is compared, is a function of the available space. Optionally, as the available space decreases, the threshold value is raised. Alternatively or additionally, the threshold value is a function of the available space, normalized by the amount of remaining data of the cluster to be processed. In some embodiments of the invention, the amount of space utilized for duplication is allowed to go beyond the determined available space, if the common column has a relatively high duplication score.

In some embodiments of the invention, the amount of duplication space is a predetermined percentage of the space required for the data of the cluster. Alternatively or additionally, the amount of duplication space increases with the cluster score.

Alternatively to repeatedly finding common columns for pairs of candidate verticals and determining whether to combine the pair of verticals immediately, all the common columns are determined together and assigned scores. The verticals with the lowest duplication scores are then combined, according to the memory constraints.

Vertical Memory Storage Type

In some embodiments of the invention, in determining (515) the verticals to be cached, resource governor 212 also determines the storage method of the vertical in in-memory database 120. In an exemplary embodiment of the invention, two methods are used for storing verticals, namely spaced and simple. Spaced verticals include empty rows distributed throughout the vertical, in order to allow adding rows to the vertical without moving a large number of rows and without loosing any sorted attribute of the vertical. Optionally, the spaced verticals are divided into pages which are easily transferred. In some embodiments of the invention, the empty rows distributed throughout the spaced verticals are located at the end of some or all of the pages. Rows of simple verticals are optionally loaded consecutively into the memory, such that in reviewing the elements of the vertical there is no need to check that the elements are valid, i.e., are not empty rows.

Optionally, the determination of which type of vertical is used is performed according to the stability of the vertical's data, i.e., according to the expected rate of change of values in the vertical. In some embodiments of the invention, verticals of tables that are not sorted are always simple, as added values can be appended at their end and removed values can be replaced by values from the end.

In some embodiments of the invention, for each base table, one of the verticals is assigned to be a clustering vertical of the base table. Generally, the clustering vertical includes the column(s) serving as the primary key of the table, as is known in the art. It is noted that the clustering vertical may include a single data column or a plurality of data columns.

Encoding

In some embodiments of the invention, in addition to determining the partition of tables, resource governor 212 optionally determines whether it is advantageous to encode any of the columns in the tables referenced by the queries of the selected cluster. Optionally, columns that carry relatively large size fields and have a relatively small number of possible values or have a relatively small number of actually used values, are encoded, in order to save memory space. In some embodiments of the invention, the encoding includes correlating to each value of the column, an integer value, which is used to represent the value in accelerator 110. Optionally, all the operations performed by accelerator 110 are performed on the encoded integer values. Output interface 222 optionally replaces the encoded integer values with the original values. It is noted that in some cases the encoding also achieves more efficient access to-the encoded columns. Sorting In some embodiments of the invention, resource governor 212 also determines whether it would be advantageous to sort the cached table in accordance with a specific key. For example, if a table not sorted in storage disk 102 (or sorted according to a different key) is accessed by a plurality of queries that require and/or take advantage of a specific sorting, the table is determined to be sorted accordingly before it is cached into in-memory database 120. Optionally, the sorting is performed only if the cost of sorting the table is lower than the expected advantage from the sorting. Alternatively or additionally, the table is sorted according to the key which is expected to provide the largest saving during execution, regardless of the sorting cost, for example if the sorting is performed by a separate pre-processing processor. Optionally, the determination of whether to perform the sorting is performed based on the load on the preprocessing processor that performs the sort, for example back end 114.

Optionally, the same row order is used in all the verticals of a single table. In some embodiments of the invention, if it is determined that sorting a table according to a plurality of keys would be advantageous, the table is sorted according to one of the keys and indices are generated for the remaining keys. Optionally, the table itself is sorted according to the key that is expected to be most advantageous. In some embodiments of the invention, a plurality of copies of the table sorted according to different keys are cached into in-memory database 120. Alternatively or additionally, the table is not sorted at all, and indices are used instead of sorting. This alternative is optionally used when the space utilization of the memory is relatively low, while the processing resources of the preprocessing unit are relatively scarce. Alternatively or additionally, this alternative is used for important columns instead of, or in addition to, caching the column twice.

Selecting Indices

Referring in more detail to determining (514) indices which are to be created for the queries of the selected cluster, in some embodiments of the invention, resource governor 212 determines the amount of storage memory available for indices and creates indices according to an importance order, until the memory available for indices is exhausted.

In some embodiments of the invention, each cluster is assigned a maximal amount of memory for indices, optionally as a function of the number of queries in the cluster, their types, their QoS priority, the cluster score and/or the amount of base memory (number of rows and/or columns) the queries reference. Optionally, clusters with a higher cluster score are given a larger amount of memory for indices. In an exemplary embodiment of the invention, the amount of memory assigned for indices of a cluster is equal to the product of the memory space required for the base data accessed by the cluster, the cluster score and a coefficient which brings the memory for indices to a predetermined percentage of the total memory of base data accessed by the cluster.

Alternatively, a fixed amount of memory is assigned for indices of all the clusters. The available memory for indices of a specific cluster is optionally determined, in this alternative, as the remaining memory for indices after the creation of the indices of the higher score clusters.

In some embodiments of the invention, the memory amount for indices is revisited after the amount of memory used for base tables in each memory unit 210 is determined. At that time point, indices are added or removed as required. Optionally, during the determining (514) of the indices to be created for each cluster, resource governor 212 determines one or more possible indices which are to be created if during the revisiting of the amount of data for indices it is determined that there is additional room for indices. Optionally, the possible indices are ordered according to their priority.

In some embodiments of the invention, in determining the importance of indices, greater weight is given to indices already existing in in-memory database 120. In some embodiments of the invention, the importance of an index is determined according to the frequency of queries that take advantage of the index, in the roster of queries. Alternatively or additionally, the importance of an index depends on the extent to which the index reduces the processing power required in order to carry out the query.

In some embodiments of the invention, the advantage of an index for a specific query and data column is determined based on the access type performed by the query in accessing the data column. Optionally, the access types are grouped in primary access type (pat) groups for the simplicity of the index determination procedure. In an exemplary embodiment of the invention, the access types include lookup (equality), range (using inequalities), order, grouping, string matching and equi-join. In this embodiment, the primary access types may include, for example, order (including range, order and string-matching), lookup (including lookup and equi-join) and grouping (including grouping). In an exemplary embodiment of the invention, a merge-join access type belongs to both the order and look-up primary access types.

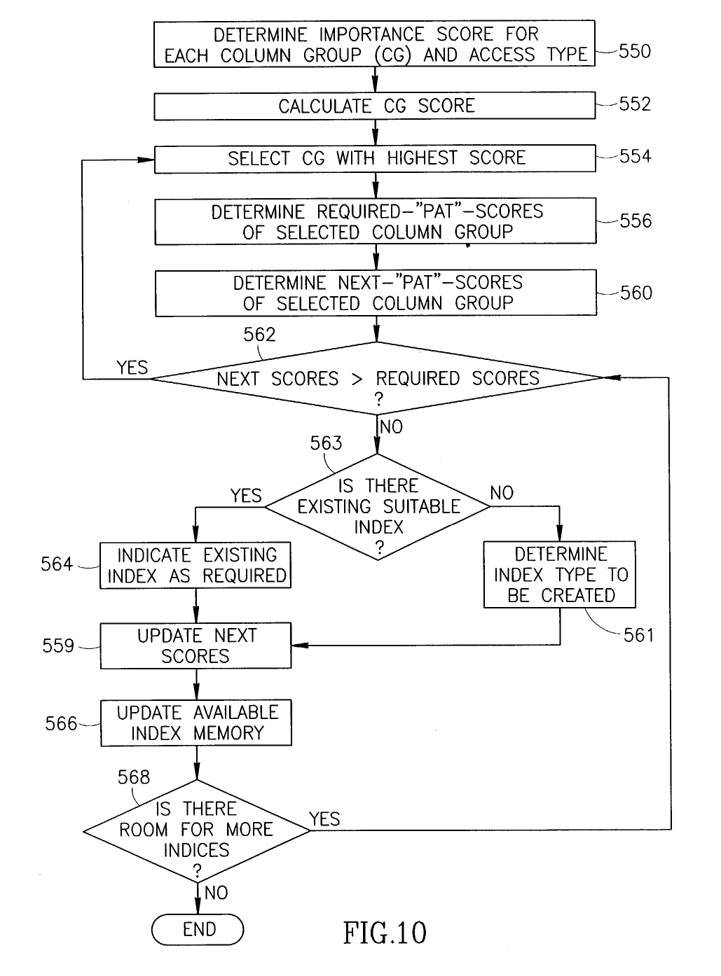

An exemplary method for selecting indices is now described with reference to FIG. 10. It is noted, however, that the method of FIG. 10 is brought by way of example, and other methods may be used to select the indices to be created, in accordance with the present invention.

FIG. 10 is a flowchart of acts performed in determining which indices are to be used for a cluster of queries, in accordance with an embodiment of the present invention. For each table column group (cg) referenced by the cluster and for each possible access type (at), resource governor 212 determines (550) a column-access score representative of the importance of having an index for that access type, for the column group. The column-access score for a pair (cg, at) is optionally equal to a sum of query scores of the queries in the cluster that reference the column group (cg) using the access type (at). Optionally, the query scores used are the scores described above with regard to assigning cluster scores. Alternatively, any other query score may be used.

In some embodiments of the invention, for each column group (cg), resource governor 212 calculates (552) a column-group (cg) score, for example as the sum of the column-access scores of all the different access types of the column, that have an access score above a threshold value. Similarly, in some embodiments of the invention, all the following acts relate only to access types that have an access score above the threshold. The relation only to access scores above the threshold prevents wasting resources on low importance column access types. Alternatively, the sum and/or following acts relate to all the access scores, even those having a low value.

The access scores of all columns are optionally compared to the same threshold. Alternatively, the threshold used for a specific column group (cg) is a function of the stability of the table including the column group, so that indices are created for column groups of relatively stable tables, as the indices may loose their validity due to changes in the table. Optionally, the threshold for each table (T) is given by a fixed threshold value divided by a stability factor of the form:

stabilityFactor(T)=1−(average number of updates for T/total number of rows of T).

In some embodiments of the invention, column groups are repeatedly selected (554) according to their scores, and indices are selected for creation as is now described, until the memory for indices of the cluster is exhausted (568).

For each primary access type (pat), a required-“pat”-score, which represents the popularity of accessing the selected column group using the primary access type, is calculated (556) for the selected column group. Optionally, the required-“pat”-score is calculated as the sum of the column-access scores of the access types belonging to the primary access type group. In some embodiments of the invention, one or more access types, such as the merge-join access type, belong to a plurality of primary access type groups. In these embodiments, the scores of access types belonging to a plurality of groups are optionally added with a weighted sum to the respective groups. Optionally, the weights of the access type in all the primary access type groups total to 1.

In addition, for each primary access type, a next-“pat”-score, which represents the importance of indices already determined to be created (e.g., for previous clusters) for accessing the selected column group using the primary access type, is optionally calculated (560). A comparison of the next-“pat”-score and the required-“pat”-score for each primary access type is optionally used in determining which indices are to be created for the column group, if at all, as described below.

Optionally, in calculating (560) the next-“pat”-score, for each index elected to be created for the column group, the queries that reference the column for which the index was created are determined, together with the access type used by each of these queries in accessing the column. The next-“pat”-score is optionally calculated (560) as a weighted sum of the query scores of the determined queries that use the primary access type for which the next-“pat”-score is determined. The weights of the sum optionally represent the usefulness of the index for the primary access type. In an exemplary embodiment of the invention, the weights used are:

| | tree index | hash index | sorted index |
|---|---|---|---|
| order pat | 1 | 0 | 1 |
| lookup pat | .75 | 1 | .5 |
| grouping pat | .75 | .75 | 1 |

Alternatively, for tree indices, the weight of queries that use the equi-join access type is lower than for other queries of the lookup primary access type, e.g., 0.5.

If (562) the next-“pat”-score is greater than the required-“pat”-score, or there is not a substantial difference therebetween, for each primary access type, no additional indices are required for the column group. Therefore, a next column group is optionally selected (554) and the above determination of whether additional indices are required is repeated for the next column group. If (562) the next-“pat”-score is substantially smaller than the required-“pat”-score, for one or more of the primary access types, resource governor 212 determines whether (563) a suitable index for closing the gap between next-“pat”-score and required-“pat”-score, already exists (was created in previous sessions of resource governor 212), but was not already elected. If (563) there is such an existing index for the column group, the existing index best suited for closing the gap is elected (564), the next-“pat” score is updated (559) accordingly and the comparison (562) of the next-“pat”-score and the required-“pat”-score is optionally repeated. If (563), however, there is no suitable existing index, an index is determined (561) to be created for the column, the next-“pat” score is updated (559) accordingly and the comparison (562) of the next-“pat”-score and the required-“pat”-score is repeated. Alternatively, only a single index is selected to be created for each column, and once an index was elected (564 or 561) a next column group is considered.

The memory required for the indices determined to be created (including indices already existent in in-memory database 120) is optionally reduced (566) from the amount of memory available for indices of the cluster. If (568) there remains memory for an additional index, the selection of indices is continued.

Optionally, in determining whether (568) there remains available memory for indices, the index memory is considered full if the total memory of the selected indices is within a predetermined margin from the amount of memory available for indices. Alternatively or additionally, when the index memory is nearly full, resource governor 212 selects an index which closely fills the index memory, even if there are indices with higher scores than the selected index.

The type of index to be created is optionally determined (561) as the index which best fills in the gap between the next-“pat”-score and the required-“pat”-score for each of the primary access types. Optionally, an index type score is determined for each index type and an index of the index type with a best score is selected.

In some embodiments of the invention, the index actually selected for the index type is determined according to the column size of the column group for which the index is generated. Optionally, the selection of the index depends on the width of the column group. In some embodiments of the invention, for columns in which each row has a small fixed-length width, such that each row can fit in its entirety to a cache of EMs 204, or EM 204 can otherwise take advantage of the width of the column group, a cache sensitive (CS) index, which takes into advantage the width of the column group, is used. In an exemplary embodiment, for EMs 204 with current cache technology, column groups are considered having a small fixed line-length if they have a width of up to 64 bits.

Optionally, for column groups having a width fitting into a small fixed-length, the CS hash index is selected for the hash index type and the sorted index is selected for the sorted index type. The CSB tree index is optionally selected for the tree index type, for columns that have a relatively high update rate (volatile verticals) and the cache sensitive array (CSA) index is optionally selected for the tree index type for columns having a low update rate (stable verticals), or which are not expected to be updated at all.

Optionally, for column groups having a large fixed-length, the open hash index is selected for the hash index type, the sorted index is selected for the sorted index type, and the B+tree index is selected for the tree index type. Optionally, for columns having a variable length, the open hash index is selected for the hash index type, the sorted pointers index is selected for the sorted index type, and the B+tree index is selected for the tree index type.

Alternatively, the number of types of indices is limited, for example, in order to simplify accelerator 110. For example, the open hash index may be used for all hash index types instead of using the CS-hash index in some cases and/or the sorted pointer index may be used instead of the B+ tree index.

In some embodiments of the invention, when a column group is determined to be accessed only using indices created for the column group, the column group itself is not cached into in-memory database 120. Optionally, precedence is given to creating indices that will make the caching of a column unnecessary. Optionally, the access type score for such column groups is adjusted according to the gain in not caching the column itself.

Alternatively to assigning a plurality of indices to column groups with high scores before low score column groups receive indices, only a single index (e.g., an index for an access method with a best score) is selected for each selected column group. Only if there is available memory space after all the column groups that have at least one access type with a score above the threshold, received an index, is a second round of assigning indices to the column groups performed.

Compilation

Referring in more detail to compiling the queries, it is noted that queries familiar to accelerator 110 were already compiled previously and therefore, in some embodiments of the invention, these queries are not provided to compiler 200 for compilation again. Alternatively or additionally, after a predetermined time and/or if the current plan achieves low performance, an additional compilation is performed in an attempt to generate a better plan.

Optionally, compiled execution plans are kept in plan depository 202 as long as the data they relate to is cached in in-memory database 120. Alternatively or additionally, old execution plans, e.g., plans prepared before at least a predetermined amount of time, and/or plans prepared under different memory occupancy conditions, are discarded from plan depository 202, so that their queries are recompiled.

Further alternatively or additionally, at least some compiled execution plans are kept in plan depository 202 even after some or all the data to which they relate is removed from in-memory database 120. In some embodiments of the invention, in accordance with this alternative, execution plans are removed from plan depository 202 only when there is no room in the instruction cache for new execution plans, which need to be stored therein.

Optionally, when a new execution plan needs to be written to plan depository 202 and there is no available room therein, the execution plan with the least chances to be used in the near future is overwritten. Optionally, the chances of an execution plan to be used are determined according to the percentage of verticals referenced by the plan, which are not currently in in-memory database 120. Alternatively or additionally, the determination is performed based on the popularity of the query, the importance of the query and/or any other relevant attribute. It is noted that in accordance with some embodiments of the present invention, old execution plans may be used even when the data to which they relate changed places in in-memory database 120, as the compilation is independent of the location of the data in the memory.

In some embodiments of the invention, in which compiled plans are not necessarily discarded when the data they reference is removed from in-memory database 120, resource governor 212 verifies that the plan is valid, before using a plan from plan depository 202. Optionally, verifying that the plan is valid includes checking that all the verticals and/or indices the plan references are stored in in-memory database 120. Optionally, if one or more of the verticals and/or indices are not available, the compiled plan is discarded. Alternatively or additionally, if possible, the plan is adjusted to operate with other indices and/or other vertical partitioning.

In some embodiments of the invention, the compilation of the selected queries is performed after the selection (514) of indices for the cluster and/or the partitioning (515) of tables into verticals. The compilation is optionally performed based on the available indices and verticals. In some embodiments of the invention, the compilation is performed before the following acts in FIG. 8, so that the compiled execution plans may be used in estimating (519) the resources required in order to handle the queries of the cluster. Alternatively, the compilation is performed in parallel to the acts of resource governor 212. Optionally, in this alternative, responsive to selecting a cluster of queries, resource governor 212 passes to compiler 200 the queries of the cluster for compiling, and continues in performing its tasks. In some embodiments of the invention, resource governor 212 skips, when possible, some of the tasks which require results from the compilation and performs other tasks (e.g., selection of a next cluster) until the results of the compilation are received. Alternatively or additionally, when resource governor 212 reaches act 522, it waits for the results of the compilation from compiler 200.

In some embodiments of the invention, after each query is compiled, the resultant plan is evaluated to ensure that the resources required by the plan are not too costly. Optionally, if the resources required are too costly, the query is rejected (i.e., is determined not to be handled by accelerator 110). In some embodiments of the invention, queries requiring more than a predetermined amount of processing power and/or communication resources are considered too costly.

Determining Required Resources of Cluster

Referring in more detail to estimating (519) the resources required for handling the queries of the selected cluster, in some embodiments of the invention, the determined resources include the memory space required in order to store the base verticals accessed by the queries of the selected cluster and the indices created for those base verticals. Optionally, for verticals and indices currently in in-memory database 120, the memory resources required are received from the in-memory database. For verticals not currently in in-memory database 120, in-memory database 120 optionally references an internally managed meta-data table, which lists for each table of the database, the number of rows it has, the types of columns it has and/or the minimum and maximum values. Alternatively or additionally, the determination is performed by querying back end unit 114 and/or by estimating. The size of indices not yet created are optionally estimated using formulas known in the art, for example based on the number of columns in the vertical for which the index is created, the data type of the columns and the created index type.

In some embodiments of the invention, as described above, accelerator 110 includes a secondary memory unit in which some of the cached data may be stored. Optionally, data that may be stored in the secondary memory is not counted in determining the available memory. For example, verticals only included in projection lists may be stored in the secondary memory substantially without affecting the acceleration benefit of accelerator 110. Such verticals are optionally not counted in determining the available memory as they may be stored in the secondary memory.

In some embodiments of the invention, the determined resources include the memory space required to store intermediate results and/or final results. The memory for intermediate results optionally also includes memory required for storing base verticals copied from one memory unit 210 to another for a specific query. Optionally, the required intermediate memory of a query plan is estimated based on results from previous executions of the plan. Optionally, accelerator 110 records for each plan a peak intermediate memory space it required. In some embodiments of the invention, the recording of the peak intermediate memory is performed according to the specific constant values of the executed plan. Alternatively or additionally, an average peak intermediate memory value is taken for all the executed plans of the same query type (e.g., regardless of constants).

In some embodiments of the invention, the estimation of the intermediate memory required is performed according to the size of the results of the query and/or the number of times data is moved between memory units 210.

Further alternatively or additionally, the determined resources include the processing power required to handle the queries of the selected cluster and/or an average processing power required to handle a query of the selected cluster. Methods for estimating the processing power of a plan were described hereinabove.

Further alternatively or additionally, the determined resources include the communication resources required to handle the queries of the selected cluster.

Optionally, the estimation of the required resources determined for the cluster score is used also for act (519) and the determination is not repeated. In some embodiments of the invention, if the determination for the cluster score for a query was performed before the indices for the query were selected, the determination is adjusted according to the results of the index selection and vertical determination.

Verification that Cluster meets Constraints

In some embodiments of the invention, the estimated required resources are compared to predetermined maximal values to determine whether the cluster meets predetermined cluster constraints. Optionally, the comparison is performed for the intermediate memory, the communication requirements and/or the processing load, as the clustering was performed while taking into account only the base memory required.

If the intermediate memory required by the cluster is beyond an allowed amount, the cluster is optionally broken into smaller clusters, as described hereinbelow with reference to the generation of the clusters. The amount of memory allowed for intermediate processing is optionally a predetermined amount which is the same for all clusters.

In some embodiments of the invention, the predetermined amount of intermediate memory allowed to a single query depends on the maximal number of queries allowed to be handled concurrently on an EM 204 (referred to herein as Conc_thread) and the amounts of intermediate memory required by the queries of the cluster requiring the most intermediate memory. Optionally, the sum of the estimated intermediate memory resources required by Conc_thread queries of the cluster requiring the highest intermediate memory resources must be lower than the total memory assigned for intermediate data in EMs 204. In some embodiments of the invention, the amount of the intermediate memory resources is multiplied by a fudge factor, e.g., between 0.6-0.8, which adds some leniency to the cluster size at the price of a higher chance that the intermediate memory will be exhausted. Optionally, if the intermediate memory is exhausted during operation, one of the plans being performed by the EM 204 is stalled until the intermediate memory is freed for its continued operation.

Alternatively, the amount of memory allowed for intermediate data of a cluster depends on the amount of memory required for the base verticals and indices of the cluster. In an exemplary embodiment of the invention, the total base and intermediate data is required to be beneath a predetermined value. Alternatively, the amount of intermediate data allowed to a cluster increases with the actual base memory accessed by the cluster, as usually clusters with larger base verticals require more intermediate memory.

In some embodiments of the invention, the processing power and/or communication needs estimated for the cluster is compared to a predetermined maximal value (or values) allowed for a cluster, for example the processing power and/or maximal communication capacity of EMs 204. If the processing power and/or communication needs exceeds the predetermined value, the cluster is optionally broken up. Alternatively or additionally, one or more queries are removed from the cluster, and marked unfamiliar, in order to reduce the processing load. In some embodiments of the invention, queries with the lowest score values are removed. Alternatively or additionally, queries that have highest processing power and/or communication requirements are removed. Optionally, the data required only by the removed queries is released from in-memory database 120, or is not loaded into the memory.

It is noted that the comparison of the cluster-required resources to maximal values may be performed at other stages, for example after the compilation is completed.

Referring in more detail to determining whether (516) accelerator 110 has resources beyond those required for already selected clusters, in some embodiments of the invention, resource governor 212 is configured with the maximal memory resources of in-memory database 120. The sum of the memory resources required by all the selected clusters is optionally compared to the maximal memory resources of in-memory database 120 to determine whether another cluster is to be selected. In some embodiments of the invention, the maximal memory resources configured into resource governor 212 are lower than the actual size of in-memory database 120 by a safety margin, that lowers the chances that during operation, the memory requirements will exceed the available memory.

In some embodiments of the invention, in determining whether there are enough memory resources, the base memory resources and the intermediate memory resources are considered together. Alternatively, the base memory resources and the intermediate memory resources are compared separately to respective maximal values configured for each of them. This alternative may be advantageous for cases in which the quality of the estimations of the intermediate data and the base memory are different.

In some embodiments of the invention, clusters already determined to be cached are considered for a second (duplicate) caching. A second caching is useful when the number of times the queries of the cluster are expected to be received is very high. If a cluster is duplicated, more than one EM 204 may execute similar queries. Optionally, in allowing for a second selection of a cluster, after a cluster is selected it is not removed from consideration, but rather its score is reduced.

Alternatively or additionally, for each cluster, resource governor 212 determines in how many EMs 204 the data of the cluster is to be cached (if cached in more than one EM 204 the data is duplicated). Optionally, the determination is performed before the resources required by the cluster are estimated (519) and the required resources reflect the number of EMs 204 in which the data of the query is cached. In some embodiments of the invention, the number of EMs 204 in which the data is stored increases with the expected processing resources and/or communication needs of the queries of the cluster and decreases with the memory the data of the cluster requires. In an exemplary embodiment of the present invention, the number of EMs 204 caching a cluster c is determined as:

num_of_machines [c]=max (1, I[load(c)+cload(c)]/mem(c)*k|)

in which load(c) is a normalized measure of the processing power required by the queries of the cluster, cload(c) is a normalized measure of the communication needs of the queries of the cluster, mem(c) is a normalized measure of the memory required by the data of the cluster and k is a suitable constant. The processing power is optionally normalized by the maximal processing power of any of EMs 204. The communication load is optionally normalized by a maximal communication capacity of any of EMs 204. The required memory is optionally normalized by the minimal memory size of memory units 210.

In some embodiments of the invention, a cluster is considered too large due to processing power requirements if there are only fewer than num_of_machines [c] EMs 204 that have lo(c)/num_of_machines [c] available processing power. Optionally, if a cluster is considered too large due to load it is partitioned into a plurality of clusters and/or queries of the cluster are removed from the roster, for example, as described below with reference to FIG. 12.

In some embodiments of the invention, each selected cluster is required to have at least a minimal cluster score. That is, if none of the candidate clusters have a high enough score, no additional clusters are selected, so that the resources of the accelerator can be better utilized for the queries of the selected clusters. Optionally, the minimal cluster score increases as the available memory space of accelerator 110 decreases, so that it is harder for a low score cluster to be selected when there is less room in the accelerator. Alternatively or additionally, the minimal cluster score increases with the expected processing power load of the already selected clusters. Further alternatively or additionally, when the score difference between the most recently selected cluster and the next cluster on line is very large, the selection process is terminated.

In some embodiments of the invention, if available memory remains after completing the selection of clusters, resource governor 212 revisits the indices determination, allowing creation of additional indices in the available memory. Alternatively or additionally, when the available resources are slightly short in order to select an additional cluster with a high score, resource governor 212 revisits the indices determination, reducing the number of indices allowed to one or more of the selected clusters, in order to make room for the additional cluster. Optionally, in determining (514) the indices, resource governor 212 prepares a list of indices ordered according to their priority. In some embodiments of the invention, the list includes one or more indices at stand-by. When resource governor revisits the index determination it simply adds or removes one or more indices from the list of the cluster.

In some embodiments of the invention, in determining (514) the indices, each index is given a global score of importance comparable to indices of other clusters. In the revisiting process, if a cluster has a selected index with a lower score than a stand-by index of a different cluster, the index selection is changed.

In some embodiments of the invention, after queries are compiled, the estimations of their cost (i.e., required processing power and/or time) are compared to more accurate data available from the compilation. If, in view of the more accurate data, the query would not have been selected, the query is marked rejected. The data required only for rejected queries is removed from the memory and splitter 112 is optionally notified that the queries are rejected. Alternatively, only queries that would not have been selected in view of the more accurate data, by a predetermined margin, are rejected. In this alternative, processing resources are not wasted on rejecting queries that the mistake in their selection is small.

Alternatively or additionally, if in view of the more accurate cost estimates there is room for more queries, the queries collected by splitter 112, but not included in the roster, are revisited. Queries that relate to data determined to be cached by in-memory database 120 are optionally compiled and added to the queries to be considered familiar. The addition of queries not included in the roster is optionally performed according to the amount of processing resources available. By revisiting the queries not included in the roster, the number of queries being compiled, not according to the decision making of the method of FIG. 8, is reduced. Optionally, the queries not included in the roster are compiled only when compiler 200 has free resources and the data placement determination does not wait for the compilation of these queries. Alternatively or additionally, at least some of the queries not included in the roster are added to the queries, which were related to in the data placement.

Data Placement

Referring in more detail to determining (522) in which of memory units 210 each of the cached portions of the database is to be positioned, in some embodiments of the invention, all the verticals referenced by a selected cluster are positioned in a single memory unit 210. Optionally, when a vertical is referenced by queries of two or more different clusters, the vertical is replicated in each of the memory units 210 hosting data of a cluster referencing the vertical. Alternatively or additionally, all the verticals referenced by a selected cluster are positioned in a single memory unit 210, except those verticals already positioned in a different memory unit 210.

In some embodiments of the invention, the positioning of the data in machines 204 is determined in a manner that distributes the processing and/or communication load between the machines as evenly as possible, based on the statistics of the query roster. Optionally, the verticals loaded into a single memory unit 210 are such that the processing power and/or communication needs required to resolve the executable queries that manipulate the loaded verticals, according to the query distribution in the roster, does not exceed the processing power and/or communication capability of the machine 204 of the memory unit 210. Alternatively or additionally, splitter 112 keeps track of the amount of queries passed to accelerator 110. When the load on one or more of the EMs 204 is expected to be very high, splitter 112 passes familiar queries which would be passed to that EM 204 to database server 104.

In some embodiments of the invention, volatile (i.e., non-stable) verticals of a single table are optionally positioned in a single memory unit 210, if possible, in order to simplify the updating of the verticals when necessary. Optionally, the importance given to placing volatile verticals of a single table in the same memory unit 210, is a function of the stability of the table.

In some embodiments of the invention, the determination (522) of the positions of the database portions is performed after the compilation of clusters is completed. Optionally, in these embodiments, the values of the resource measures used in positioning the database portions in memory units 120 are values determined the compilation of the queries. Alternatively, the determination of the positioning of the database portions of each cluster is performed after the selection of the cluster, before, or in parallel to, the compilation of the queries of the cluster. In this alternative, the positioning is performed based on estimates of the resources required for the database portions, optionally the same estimates used in selecting the clusters.

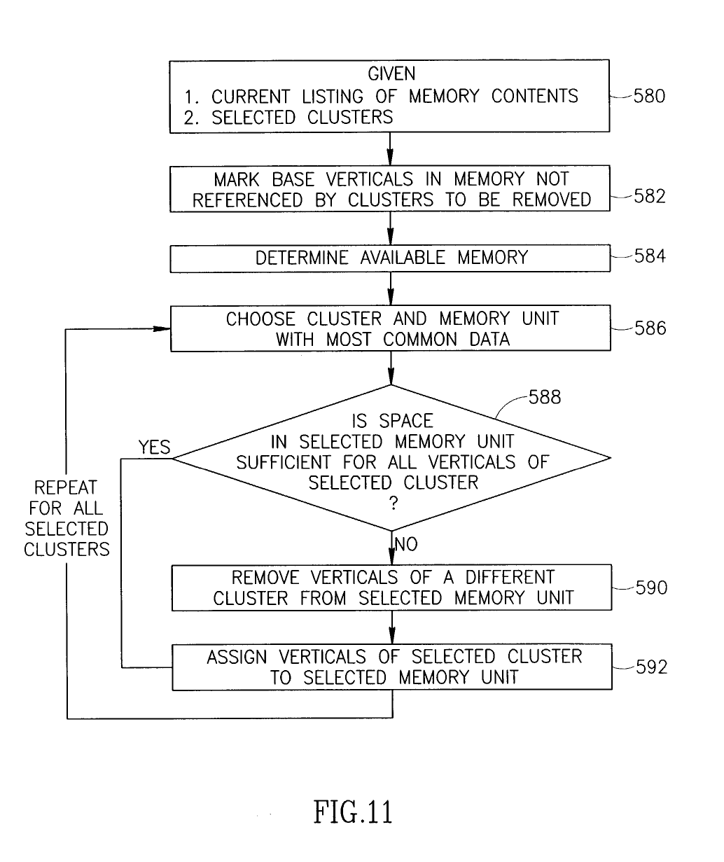

FIG. 11 is a flowchart of acts performed in determining (522) in which of memory units 210 each of the portions of the database is to be positioned, in accordance with an exemplary embodiment of the present invention. The determination of the placement of the cached portions of the database optionally starts with (580) a listing of the current contents of each of memory units 210 and a list of the selected clusters. In some embodiments of the invention, base verticals, in memory units 210, that are not referenced by the selected clusters are marked (582) to be removed from the in-memory database 120. Optionally, the available memory in each memory unit 210, after removing the marked verticals, is determined (584). A pair of a cluster and a memory unit 210 that have a largest amount of common data is optionally chosen (586).

If (588) the available memory in the memory unit 210 of the chosen pair is sufficient for all the verticals referenced by the cluster of the chosen pair, the verticals referenced by the chosen cluster are assigned (592) to the chosen memory unit 210. If (588), however, the available memory is not sufficient, verticals of one or more other clusters, with lower cluster scores, are marked (590) to be removed from the memory unit 210, in order to make room for the verticals of the chosen cluster. In some embodiments of the invention, if it is not possible to remove from the memory unit one or more verticals which provide sufficient space for storing the data of the chosen cluster, the chosen cluster is skipped and a different pair of cluster and memory unit is chosen (586).

The choosing (586) of a pair of cluster and memory unit 210 is optionally repeated, until all the verticals referenced by the selected clusters are assigned to memory units.

Referring in more detail to choosing (586) a pair of a cluster and a memory unit 210, in some embodiments of the invention, in choosing the pair, it is verified that room in the chosen memory unit 210 is available or can be made available, for example by removing data accessed by clusters having a lower cluster score, for the verticals of the chosen cluster. Otherwise, the pair of cluster and memory unit are not chosen and a pair for which sufficient memory is available is optionally chosen, even if the pair has a lower amount of common data.

In some embodiments of the invention, the choosing of a pair of a cluster and a memory unit 120 is performed by determining for each combination of a cluster and a memory unit 120, the size of the verticals and indices currently stored in the memory unit which are referenced by at least one of the queries of the cluster. Optionally, if two or more cluster and memory unit combinations have substantially the same size of their common verticals and indices, the cluster with the higher cluster score is chosen.

Optionally, if one or more clusters remain that cannot have their data stored in a single memory unit 210, an attempt is made to break these clusters into smaller clusters. If one or more clusters cannot be broken up efficiently (i.e., without having queries closer to each other than to other queries in their cluster being in different clusters), the data of these clusters is distributed between a plurality of memory units. In some embodiments of the invention, for a cluster whose data is to be distributed between memory units 210, the resource governor 212 determines which data referenced by the cluster is expected to be used the least, and this data is placed in a separate memory unit 210. Optionally, if the difference between the available space for data of the cluster and the volume of the data referenced by the cluster is relatively small, resource governor 212 cancels one or more of the indices of the data of the cluster, in order that the data fit in the available memory space.

Alternatively or additionally, one or more of the selected clusters or some of the queries of the one or more selected clusters are rejected and the data they require is not loaded into in-memory database 120. Optionally, whether the data of a cluster will be distributed between a plurality of memory units 210 or one or more queries will be rejected, is determined according to the average processing load expected for the selected clusters. When the expected load is relatively high, the number of rejected queries is optionally accordingly large. On the other hand, when the expected load is relatively low, the number of rejected queries is low, or even no queries are rejected. Alternatively or additionally, whether the data of a cluster will be distributed between a plurality of memory units 210 or one or more queries will be rejected, is determined according to the number of memory units 210 which are needed to store the data of the cluster. If the data of the cluster needs to be stored in more than a predetermined number of memory units 210, queries of the cluster are optionally rejected.

Alternatively to choosing pairs of clusters and memory units 120 according to the absolute amount of common memory, the pair with the highest percentage of data already stored in the memory unit 120, is chosen. Further alternatively or additionally, the clusters are chosen according to their cluster score, and for each cluster, a memory unit 120 with a highest common memory with the cluster, is chosen to host the cluster. Further alternatively or additionally, the clusters are chosen according to the amount of data they reference, such that the cluster with the largest amount of data is assigned to a memory unit 120 before clusters referencing lower amounts of data. In some embodiments of the invention, the cluster to be handled next is determined based on a weighted sum of scores given according to a plurality of the above mentioned considerations.

Referring in more detail to assigning (592) verticals to the selected memory unit, in some embodiments of the invention, those verticals already stored in other memory units 210 are marked to be removed from their old memory units 210.

Referring in more detail to marking (590) verticals of one or more other clusters to be removed from the memory unit 210, the verticals marked to be removed are optionally those which belong to a cluster having a lowest correlation (i.e., a cluster whose queries relate the least to the verticals accessed by the current cluster) to the memory unit 210. Alternatively or additionally, the verticals marked to be removed are selected according to their size so that they substantially precisely provide the required space. Further alternatively or additionally, no specific verticals are marked to be removed, but rather the available space of the memory unit 210 is marked as being in deficit. In selecting consequent pairs, the deficit in the available space of the memory unit 210 is taken into account. That is, verticals of clusters assigned to other memory units 210 will be marked to be removed from the memory unit 210, thus leveling the available space of the memory unit 210 with the data assigned to the memory unit.

In some embodiments of the invention, the verticals assigned to each of the memory units 210 are reviewed in order to make sure that two copies of the same vertical are not placed in the same memory unit 210, for different clusters. If such verticals are found, one of the copies is eliminated. Alternatively or additionally, when verticals are placed into EMs 204, it is verified that the queries to be handled by each EM 204 do not exhaust the resources (e.g., processing power, communication capacity) of the EM.

Generating Coloring Sets

In some embodiments of the invention, in determining (522) the positioning of the verticals, resource governor 212 generates coloring sets, as defined above with reference to FIG. 5, for some or all of the queries in the selected clusters.

In some embodiments of the invention, generating the coloring sets for a query comprises determining all the verticals referenced by the query. For each vertical referenced by the query, all the memory units 210 hosting a copy of the vertical are determined. One or more minimal groups of memory units 210 (i.e., including the smallest number of memory units 210 possible), which host all the verticals required by the query, are determined. For one or more of the determined minimal groups of memory units 210, a mapping of verticals to the memory units of the group is determined, to form respective coloring sets. In some embodiments of the invention, coloring sets are generated for each determined minimal group of memory units 210, so that the selection by dispatcher 206 of an optimal coloring set uses a largest span of possibilities. Alternatively or additionally, the number of coloring sets is limited to a predetermined maximal number (e.g., 5-10), in order to limit the resources spent on the optimization.

In the method of FIG. 8, the determination of which verticals (515) and indices (514) are to be created for a cluster, is performed only after a cluster is selected. Thus, processing resources are not wasted on clusters not selected. Alternatively, the selection of verticals and indices is performed for all the clusters, before the selection of clusters. Thus, the information generated during determination of verticals and indices of the queries of the roster can be used in better estimating the parameters of the scores of the clusters.

Referring in more detail to updating (524) the contents of in-memory database 120 according to the determination, in some embodiments of the invention, implementing the changes is commenced after completing the determining (522) of the positioning of the portions. Alternatively, implementing the changes is commenced at a predetermined time after the previous implementation of changes was performed.

In some embodiments of the invention, implementing the changes is performed gradually (e.g., for each EM 204 separately) while allowing accelerator 110 to continue its operation throughout the implementation of the changes (e.g., those EMs 204 not currently being changed). Optionally, the changes are implemented sequentially in the memory units 210. In some embodiments of the invention, a first memory unit 210 is selected for implementing the changes. The queries to be affected by the changes in the selected memory unit 210 are marked as unfamiliar and splitter 112 is notified accordingly. Optionally, queries that are affected by the changes only temporarily are marked as frozen, until the data they require is reinstalled in one or more other memory units 210. The data in the selected memory unit 210 that is not to be moved to any other memory unit 210 is discarded. Data to be removed to other memory units 210 is optionally transferred to a temporary storage unit, for example a secondary disk, for retrieval by other memory units 210.

Thereafter, the data to be imported to the selected memory unit 210 is loaded into the memory unit. Data imported from other memory units 210 is discarded from these memory units, unless the data was indicated as being cached twice. In some embodiments of the invention, the data is erased only when the storage space occupied by the data is required for other data. Optionally, the discarding of the data is performed only after the update in memory unit 210 is complete. The indices required to be created for memory unit 210 are created by in-memory database 120 and stored in the memory database. The queries that can be handled by memory unit 210 in view of the changes are then marked as familiar and splitter 112 is notified accordingly.

The above implementation process is optionally repeated for each of memory units 210 until the update of accelerator 110 is completed. In some embodiments of the invention, memory units 210 are selected according to the amount of data they discard completely (not transferred to other memory units 210) and the amount of data they retrieve from other memory units 210, such that the selected memory units require the least temporary memory space.

Alternatively or additionally, the implementation of the changes is performed intermittently for different memory units 210, in a manner which minimizes the required temporary memory. Optionally, queries not supported by accelerator 110 according to the new decisions are marked unfamiliar and their data is removed from the memory units 210. Thereafter, data is moved between memory units 210 according to the available memory in the memory units 210. In some embodiments of the invention, the order in which the update is performed (e.g., which data is cached first and which later) is determined together with the determination of the placement of the data in the memory units 210.

Clustering

FIG. 12 is a flowchart of acts performed during a clustering procedure, in accordance with an embodiment of the present invention. An arbitrary query is selected (600) as a hub for a first cluster. A query with a farthest distance from the first hub, e.g., not relating to any common tables, is optionally selected (602) as a second hub for a second cluster. Each of the remaining queries is then assigned (604) to the cluster whose hub is closest to the query.

An average hub radius (R) is calculated (606) as half the distance between the hubs. If (608) there exists in one of the clusters a query whose distance from the hub of the cluster is greater than the average hub radius R, a query in the cluster, optionally the query which is farthest from the hub, is selected (610) as an additional hub for an additional cluster. All the queries, in any of the other hubs, which are closer to the additional hub than to the hub of the cluster to which they belong are re-assigned (612) to the additional cluster.

The average hub radius R is recalculated as half the average distance between all the hubs (hₖ), e.g.,

$$R = \frac{1}{n} {\sum }_{i \neq j} d ( {h}_{i} , {h}_{j} ) ,$$

where n is the number of clusters. Steps 608, 610 and 612 are optionally repeated for the new value of R, until there are no queries whose distance from the hub of their cluster is greater than R.

For each of the resultant clusters, resource governor 212 estimates (614) the memory, processing and/or communication requirements of the cluster. If (616) the memory, processing and/or communication requirements of a cluster C are greater than a predetermined maximal allowed value for clusters, the queries of cluster C are partitioned (618) into a plurality of clusters.

Referring in more detail to selecting (600) a hub for the first cluster, alternatively to selecting an arbitrary query, a most popular query, or a highly popular query, is selected. Further alternatively or additionally, a query which references a relatively small amount of data is selected such that the hub is relatively distinct and will gather a relatively small amount of queries around it. Alternatively, a query which references a relatively large amount of data is selected in order to form a relatively large cluster for the initial two cluster distribution. Further alternatively, a query already familiar to accelerator 110 is selected, such that the first cluster centers around a query already familiar to accelerator 110.

In an exemplary embodiment of the invention, a weight function of queries is defined as a function of the popularity of the query and the access needs of the query. The weight function optionally represents the importance of the access needs of the query. In some embodiments of the invention, the hub for the first cluster is selected as the query with the heaviest weight.

Referring in more detail to selecting (602) a second hub or selecting an additional hub (610), optionally, if a plurality of queries are at a same farthest distance from the first hub, a highly popular query, a query which references a specific amount of data, a query of a certain operand, a heaviest query and/or a query of any other specific attribute is selected. Alternatively or additionally, a heaviest query whose distance exceeds the average hub radius, is selected.

Referring in more detail to estimating (614) the memory requirements of the clusters, in some embodiments of the invention, the estimated memory requirements include only the memory required for base columns. Alternatively, the estimated memory includes also the memory required for indices of the base columns and/or memory required for intermediate results. Optionally, resource governor 212 determines, for each cluster, the data columns referenced by the queries of the cluster. For those data columns already in in-memory database 120, the required memory for the columns is received precisely from in-memory database 120. For other data columns, an estimate of their size is optionally received generated by in-memory database 120.

Optionally, the memory required for indices and/or the required intermediate memory is estimated as a predetermined percent of the memory of the base columns. Alternatively or additionally, the memory for indices and/or for intermediate results is estimated according to the number of columns referenced by the queries of the cluster and/or the types of operations performed by the queries of the cluster. Further alternatively or additionally, the memory requirements are estimated according to any of the methods described above.

Referring in more detail to partitioning (618) a large cluster into smaller clusters, optionally the partitioning is achieved by performing the acts 600-612 on the large cluster. Optionally, in partitioning, a smaller distance than the radius is used in determining (608) whether to generate another hub. For example, a fraction of the average radius may be used, e.g., 60-80%. Alternatively or additionally, for example when acts 600-612 do not succeed to partition the cluster, the size of the cluster is reduced by removing some of its queries from the roster. The queries removed from the roster may include, for example, queries which relate to large amounts of data and/or low importance queries. Alternatively or additionally, the removed queries include queries that relate to data needed by only few queries, such that by removing only few queries from the roster the data they require does not need to be cached.

Further alternatively or additionally, the cluster is partitioned arbitrarily into two or more clusters by selecting two queries farthest from each other as hubs and assigning each of the other queries to the closest hub. Further alternatively or additionally, for example when the partitioning (618) is required due to the cost of the queries, the data of the cluster is cached twice.

In some embodiments of the invention, instead of using the above method which may frequently change the clustering of the queries familiar to accelerator 110, a method which attempts to keep previously determined clusters is used.

In an exemplary embodiment of the present invention, in determining the clusters, the clusters currently used by accelerator 110 are used as a starting point. From each cluster, the queries not in the new roster are removed. If the hub was removed, a different hub is selected for the cluster. Thereafter, the unassigned new queries in the roster are assigned to the clusters according to the distances from the hubs, for example as described above with reference to FIG. 12. Alternatively, all the queries in the new roster, which are not hubs, are reassigned to the new set of hubs.

In some embodiments of the invention, when all the queries of a cluster are not in the new roster the cluster is canceled. Alternatively or additionally, when a cluster has fewer than a predetermined number of claims, relates to fewer than a predetermined number of columns and/or lost more than a predetermined percentage of its queries and/or its data, the cluster is deleted. The queries of the deleted clusters are then optionally assigned to other queries along with the new queries in the cluster.

In some embodiments of the invention, when a hub is removed from a cluster, the replacement hub is selected as the query closest to the removed hub. Alternatively, the replacement hub is chosen as the heaviest hub in a proximity of the removed hub, for example within the radius of the hub as calculated for its old query members, before or after removing the queries not in the new roster. Further alternatively or additionally, the new hub is chosen based on any other compromise between selecting a high weight and selecting a close query.

Optionally, the method of FIG. 12 from act 606 and on, is applied to the resultant clusters in order to refine the clusters and/or break up large clusters. Alternatively, only the acts 614, 616 and 618 are performed, in order to limit the changes of the clusters only to cases when the changes (e.g., partitioning of a cluster into two) have a significant effect.

In some embodiments of the invention, the method of FIG. 12 is used at start up and/or during a warm up period, while a method which uses previous clusters is used at other times. Alternatively or additionally, the method of FIG. 12 is used periodically, for example every 50 determination sessions of resource governor 212, so as to allow for changes in the state of accelerator 110, without the attempt of proximity keeping accelerator 110 in a local maximum.

In some embodiments of the invention, compiler 200 generates a plurality of compiled plans for at least some of the queries. For example, one plan may be generated to optimize throughput while another plan is generated so as to optimize response time. The determination of which plan is used is optionally performed responsive to an accelerator mode. Optionally, when system 100 is loaded, throughput mode is used to reduce the load, while when system 100 is relatively not loaded, response time mode is used to provide faster response times.

Alternatively or additionally, different plans may be used for different constant values of the query and/or for different query priorities.

Although in the above description, for simplicity of the description, only a single splitter 112 was mentioned, in some embodiments of the invention, accelerator 110 may operate with a plurality of splitters. The roster is optionally generated by combining the data from different splitters. In some embodiments of the invention, different splitters are assigned different importance priorities and the queries from different splitters are given different importance scores.

In some embodiments of the invention, accelerator 110 manages predetermined plans for resolving concurrently batches of popular queries of specific characteristics. Optionally, queries that can be resolved by one of these batch plans are accumulated, by dispatcher 206, for a predetermined time (e.g., 0.1-0.5 seconds). Thereafter, all the accumulated queries are resolved together in a single running of the batch plan. Optionally, high importance queries of types that can be handled by batch plans are handled separately in order to achieve fast response times for these plans.

In some embodiments of the invention, splitter 112, and/or an intermediate preprocessor between splitter 112 and dispatcher 206, break up some or all of the familiar queries into query fragments that, at least some of which, can be easily handled in batch processing. Those query fragments that can be resolved by batch plans and the remaining fragments are resolved as described above for regular queries. The results of the query fragments are then combined, for example, by a post-processor. The resolving of query fragments in batches achieves a much higher throughput of queries as the data may be reviewed once for a plurality of queries. The fragmentation is optionally performed using any of the methods described in PCT application PCT/IL02/00135 or in Israel patent application 145,040, filed Aug. 21, 2001, the disclosures of which documents is incorporated herein by reference.

It will be appreciated that the above described methods may be varied in many ways, including, performing a plurality of steps concurrently, changing the order of steps and changing the exact implementation used. For example, the vertical decomposition may be performed before the index selection instead of after and/or the compilation of queries may be performed before the index selection and/or the vertical decomposition. In addition, some of the acts, for example in the method of FIG. 8, may be repeated or revisited in view of additional information from other acts. It should also be appreciated that the above described description of methods and apparatus are to be interpreted as including apparatus for carrying out the methods and methods of using the apparatus. Headers placed in the summary and/or in the detailed description are used only for the convenience of the reader and in no way limit the scope of the invention.

The present invention has been described using non-limiting detailed descriptions of embodiments thereof that are provided by way of example and are not intended to limit the scope of the invention. For example, many different scores than those described above may be used in selecting queries. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. It will be appreciated that not all the aspects of the invention need be implemented together and that an accelerator and/or database system may be improved by implementing one or several of the aspects, even without implementing others of the aspects.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A database server accelerator, comprising:
a plurality of query execution machines, adapted to resolve database queries;
a plurality of respective memory units, adapted to cache data from the database, each memory unit being accessible only by its respective execution machine; and
a data-manager adapted to determine the data to be cached in each of the plurality of memory units.

2. An accelerator according to claim 1, wherein the plurality of execution machines are included in a single casing.

3. An accelerator according to claim 1, comprising a query dispatcher adapted to provide queries to the plurality of query execution machines.

4. An accelerator according to claim 3, wherein the query dispatcher is adapted to provide at least some of the queries to a plurality of execution machines which jointly resolve the at least some queries.

5. An accelerator according to claim 3, wherein the query dispatcher is adapted to select one or more query machines to perform a query, at least partially according to the data referred to by the query and the data stored in the memory units.

6. An accelerator according to claim 1, wherein at least one of the execution machines comprises a plurality of processors.

7. An accelerator according to claim 6, wherein each of the plurality of processors of a specific execution machine can access all the address space of the respective memory unit of the execution machine.

8. An accelerator according to claim 6, wherein at least one of the processors of a specific execution machine can access only a portion of the address space of the respective memory unit of the execution machine.

9. An accelerator according to claim 1, wherein at least two of the execution machines have different processing powers.

10. An accelerator according to claim 1, wherein all the execution machines have the same processing power.

11. An accelerator according to claim 1, wherein at least two of the memory units have different storage space.

12. An accelerator according to claim 1, wherein all the memory units have the same storage space.

13. An accelerator according to claim 1, wherein at least two of the execution machines are adapted to resolve different types of queries.

14. An accelerator according to claim 1, wherein the data-manager is adapted to have each memory unit cache only data not stored in any of the other memory units.

15. An accelerator according to claim 1, wherein the data-manager is adapted to have at least two memory units store at least one common data portion.

16. An accelerator according to claim 15, wherein the data-manager is adapted to have at least two memory units cache the same data.

17. An accelerator according to claim 1, comprising a compiler adapted to convert queries provided to a plurality of the execution machines into operator statements executable by the machines.

18. An accelerator according to claim 1, wherein the data-manager is adapted to determine the data to be cached according to a roster of queries recently received by a system including the accelerator.

19. An accelerator according to claim 18, wherein the data-manager is adapted to determine the data to be cached based on the response times of the accelerator and at least one database server to at least one of the queries of the roster.

20. An accelerator according to claim 1, wherein the data-manager is adapted to repeatedly determine periodically the data to be cached in each of the plurality of memory units.

21. A method of preparing a database command for execution by a multi-executor database server, comprising:
receiving a high level database command;
retrieving, from an execution plan cache, an execution plan including one or more executable operator statements, corresponding to the received database command, the execution plan not defining which executor is to execute each of the operator statements; and
converting the execution plan into an operational plan that, for each of the operator statements, states a group of one or more executors from which an executor which is to execute the statement is to be selected.

22. A method according to claim 21, wherein converting the execution plan into a operational plan comprises converting into a operational plan that states for each of the operator statements a single executor which is to execute the statement.

23. A method according to claim 21, wherein converting the execution plan into a operational plan comprises converting using a method adapted to minimize the number of executors used in handling the command.

24. A method according to claim 21, wherein for each statement, the group of one or more executors includes all the executors stated for other statements of the plan that generate data required by the statement.

25. A database server, comprising:
a plurality of database execution machines;
a plurality of memory units, associated respectively with the execution machines, adapted to store data of a database; and
a resource governor adapted to periodically determine which portions of the database are to be stored in each of the memory units.

26. A database server according to claim 25, wherein the resource governor is adapted to determine a transfer of a database portion from a first memory unit to a second memory unit.

27. A database server according to claim 25, wherein the resource governor is adapted to determine which portions of the database are to be stored in each of the memory units responsive to a roster of queries recently received by a system including the database server.

28. A database server according to claim 27, wherein the resource governor is adapted to group the queries of the roster into clusters and to determine the portions of the database to be stored in each of the memory units in a manner which preferentially places data referenced by queries of a single cluster in the same memory unit.

29. A database server, comprising:
at least one memory unit adapted to store data of a database;
a resource governor adapted to periodically determine which indices should be created for which portions of the database stored in the memory unit; and
an index creating unit adapted to automatically create the indices determined by the resource governor, responsive to the periodic determination.

30. A database server according to claim 29, wherein the resource governor is adapted to determine the indices that should be created at least partially according to a roster of queries recently directed to a system including the database server.

31. A database server according to claim 30, wherein the resource governor is adapted to organize the queries of the roster into clusters, to assign importance scores to the clusters and to determine the indices to be created for one or more of the clusters at least partially according to an order of the scores of the clusters.

32. A database server according to claim 31, wherein for one or more of the clusters, the resource governor is adapted to determine for one or more columns referenced by queries of the cluster, access types most commonly used in accessing the columns and to select one or more indices for the column at least partially according to the determined access types.

33. A method of resolving a database command, comprising:
receiving a high level database command;
retrieving an execution plan corresponding to the received database command, the execution plan including at least one non-executable replaceable directive representing a group of a plurality of different sequences of one or more directives, which perform the same task; and
replacing the non-executable replaceable directive by one of the sequences of the group.

34. A method according to claim 33, wherein receiving the high level database command comprises receiving an SQL command.

35. A method according to claim 33, wherein replacing the non-executable directive comprises selecting one of the sequences of the group to replace the non-executable directive, at least partially according to at least one parameter of data generated by the at least one of the directives of the plan executed before the replacement.

36. A method according to claim 35, wherein the at least one parameter comprises a number of rows of in the generated data.

37. A method according to claim 33, wherein replacing the non-executable directive comprises selecting one of the sequences of the group to replace the non-executable directive, depending on one or both of a time utilized so far to execute the plan or an expected time remaining until completion of the plan.

38. A method according to claim 33, wherein replacing the non-executable directive comprises selecting one of the sequences of the group to replace the non-executable directive, depending on at least one state parameter of an execution machine executing the plan.

39. A method according to claim 38, wherein the at least one state parameter comprises a work load of the execution machine.

40. A method according to claim 38, wherein the at least one state parameter comprises a number of queries waiting to be executed by the machine.

41. A method according to claim 38, wherein the at least one state parameter comprises an amount of available memory in the machine.

42. A method according to claim 33, wherein replacing the non-executable directive comprises replacing after executing at least one of the directives of the plan.

43. A method according to claim 33, wherein replacing the non-executable directive comprises replacing by a processor which is to execute the segment replacing the non-executable directive.

44. A method according to claim 33, wherein replacing the non-executable directive comprises replacing by an executor which did not generate the execution plan.

45. A method according to claim 33, wherein each of the sequences of one or more directives comprises a single directive.

46. A method according to claim 33, wherein at least one of the sequences of one or more directives comprises a plurality of directives.

47. A method according to claim 33, comprising estimating an execution time of each of a plurality of the sequences of the group and replacing the non-executable directive comprises replacing by a sequence having a shortest execution time.

48. A method of caching data by a database server accelerator, comprising:
selecting queries to be handled by the accelerator; and
caching the data required to resolve the selected queries, responsive to the selection.

49. A method according to claim 48, wherein selecting the queries to be handled by the accelerator comprises estimating, for a plurality of queries, the benefit to the queries from handling the queries by the accelerator and selecting the queries to be handled by the accelerator responsive to the estimation.

50. A method according to claim 49, wherein estimating the benefit to the queries comprises estimating, for each of the plurality of queries, the difference between the handling time of the query by the accelerator and the handling time of the query by at least one database server.

51. A method according to claim 49, wherein determining which queries are to be handled by the accelerator comprises assigning each of the queries an acceleration score and determining the handled queries at least partially according to the scores, preferring queries with higher scores to be handled by the accelerator.

52. A method according to claim 51, wherein determining the handled queries comprises grouping the queries into clusters and determining one or more clusters of queries to be handled.

53. A method according to claim 52, wherein grouping the queries into clusters comprises grouping queries relating to the same data columns in same clusters.

54. A method according to claim 51, wherein better acceleration scores are given to queries with higher QoS ratings.

55. A method according to claim 51, wherein the acceleration score increases with the popularity of the query.

56. A method of determining a data organization of data of a database, comprising:
accumulating a roster of queries recently directed to the database;
grouping the queries of the roster into a plurality of clusters;
arranging the clusters in an order in which their data is to be handled; and
determining an organization for the data of queries of one or more clusters at least partially according to the order from the arranging.

57. A method according to claim 56, wherein accumulating the roster of queries comprises accumulating queries directed to the database in a recent predetermined time period.

58. A method according to claim 56, wherein accumulating the roster of queries comprises accumulating queries which were recently directed to the database at least a predetermined number of times.

59. A method according to claim 56, wherein grouping the queries into clusters comprises grouping the queries at least partially according to the data portions they reference.

60. A method according to claim 56, comprising defining a query distance function which provides a distance measure for pairs of queries and wherein grouping the queries into clusters comprises grouping queries into clusters which each has a respective hub query, such that the distance between each query and the hub of the cluster to which the query is assigned is shorter than the distance to any other hub.

61. A method according to claim 60, wherein the value of the query distance function depends on the number of data portions referenced by both the queries to which the function is applied.

62. A method according to claim 60, wherein the value of the query distance function depends on the sizes of data portions referenced by both the queries to which the function is applied.

63. A method according to claim 60, wherein the value of the query distance function depends on the similarity of the access types used by the queries to which the function is applied in accessing data portions referenced by both the queries.

64. A method according to claim 60, wherein grouping the queries into clusters comprises grouping such that each query is included in only a single cluster.

65. A method according to claim 56, wherein grouping the queries into clusters comprises grouping such that all the data portions referenced by queries of a single cluster can be hosted by a single execution machine of a server of the database.

66. A method according to claim 56, wherein arranging the clusters comprises assigning each cluster a score and organizing the clusters at least partially according to the score values.

67. A method according to claim 66, wherein the cluster score depends on resources required in order to handle the queries of the cluster.

68. A method according to claim 66, wherein the cluster score depends on resources required in order to organize the data required by the cluster.

69. A method according to claim 66, wherein the organization is performed for a database accelerator and wherein the cluster score depends on an expected advantage from handling the queries of the cluster by the accelerator as compared to handling by a database server associated with the accelerator.

70. A method according to claim 56, wherein determining an organization for the data comprises determining which indices are to be created.

71. A method according to claim 56, wherein determining an organization for the data comprises determining which data portions are to be cached by an accelerator.

72. A method according to claim 56, wherein determining an organization for the data comprises determining a partitioning of one or more data tables.

73. A method according to claim 56, wherein determining an organization for the data comprises determining which data portions are to be hosted by each of a plurality of separate execution machines.

74. A method of determining whether a query is to be handled by an accelerator, comprising:
determining whether the query can be resolved by the accelerator with its currently cached data;
determining at least one additional attribute of the accelerator or the query; and
determining whether to handle the query by the accelerator, responsive to the at least one additional attribute.

75. A method according to claim 74, wherein the at least one additional attribute comprises a current load of the accelerator.

76. A method according to claim 74, wherein the at least one additional attribute comprises an expected response time of the accelerator for the query.

77. A method according to claim 74, wherein the at least one additional attribute comprises an expected response time of a database server accelerated by the accelerator, for the query.

78. A method according to claim 74, wherein the at least one additional attribute comprises whether the accelerator has a compiled version of the query.

79. A database server, comprising:
at least one memory unit adapted to store data of a database including tables, in verticals including one or more columns of the table, at least one of the tables being stored in a plurality of separate verticals; and
an execution machine adapted to resolve queries using the data in the at least one memory unit, the execution machine adapted to always load into a processor of the machine entire rows of verticals on which it operates.

80. A server according to claim 79, wherein the execution machine is not adapted to execute directives that relate to a plurality of verticals of a single table.

81. A server according to claim 79, comprising a resource governor adapted to determine which columns of a table are to be stored in the at least one memory unit in a single vertical, at least partially according to directives expected to be performed by the execution machine.

82. A server according to claim 79, wherein the at least one memory unit is adapted to store only a portion of at least one table.

83. A database server, comprising:
at least one memory unit adapted to store data of a database including tables, at least one of the tables being stored in a plurality of separate sub-portions;
an execution machine adapted to resolve queries using the data in the at least one memory unit; and
a resource governor adapted to determine the sub-groups in which the data to be stored in the at least one memory unit are to be organized, at least partially according to the queries expected to be received by the database server.

84. A server according to claim 83, wherein the execution machine is not adapted to execute directives that relate to data in a plurality of sub-portions of a single table.
